(19) United States
(12) Patent Application Publication
(10) Pub. No.: US 2005/0172118 A1
(43) Pub. Date: Aug. 4, 2005

(54) Electronic apparatus, image forming apparatus, method for controlling electronic apparatus, and system for managing image forming apparatus

(76) Inventor: Masami Nasu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/012,327

(22) Filed: Dec. 16, 2004

(30) Foreign Application Priority Data
Dec. 16, 2003 (JP) 2003-418673
Nov. 25, 2004 (JP) 2004-339850

(51) Int. Cl. G03G 15/00

(52) U.S. Cl. 713/156; 382/100; 399/24; 340/5.8

(57) ABSTRACT

In an electronic apparatus capable of using a component recording a digital certificate, the digital certificate recorded in the component is obtained, the component is authenticated by using the digital certificate. An operation of the electronic apparatus is controlled based on an authentication result by the authenticating part.

### BACKGROUND OF THE INVENTION

1. Field of the Invention

The present invention generally relates to an electronic apparatus, an image forming apparatus, a method for controlling the electronic apparatus, and a system including the image forming apparatus and the managing apparatus for managing the image forming apparatus.

2. Description of the Related Art

Conventionally, in various apparatuses, a component is configured to be detachable form. Accordingly, even if the component is damaged, abraded or consumed, or is used up since a product life as the unit wears out, an operation as the entire apparatus can be maintained since the component is easily replaceable by a user or a service person.

Thus, this configuration is important, especially for an apparatus using a component having lower durability than other components and a consumable component being consumed in accordance with an operation of the apparatus. The component having lower durability and the consumable component is appropriately replaced with another consumable component to maintain the operation of the apparatus. In the following, these components are collectively called consumable components.

As an example of the above-described unit, a process cartridge for an image formation used in an image forming apparatus such as a printer, a digital copier, a multi-functional digital printer, and a like is illustrated. In addition, in the image forming apparatus, each of units such as a photosensitive drum, an electrostatic unit, a development unit, a toner bottle, a cleaning unit, an optical unit, a transfer unit, a paper cassette unit, a fixing unit, and a like can be replaceable.

These consumable components are generally distributed as replaceable units, and are not always distributed in the same manner as a main device of the apparatus. Moreover, recently, in addition to a manufacturer of the main device, other manufacturers including manufacturers not related to the manufacturer supply the main device produce those replaceable units and non-authentic replaceable units.

However, the quality of the non-authentic units (produced by manufacturers irrelevant to the manufacturer of the apparatus using the replaceable units and produced under a circumstance in which the manufacturer of the apparatus using the replaceable units cannot sufficiently manage the quality) cannot be managed by the manufacturer supplying the main device. Accordingly, in a case of using the non-authentic units, an operation of the apparatus cannot always guaranteed. Even if the apparatus seems to operate normally, detailed parts of the apparatus tend to have defects and cause problems. For example, in a case of the image forming apparatus, a quality to form an image is degraded. Once this problem occurs, reliability of the apparatus itself can be lowered.

Thus, the manufacturer supplying the main device wants users of the apparatus to use authentic units (produced by the manufacturer itself of the apparatus using the replaceable units or produced under the circumstance in which the manufacturer of the main device can sufficiently manage the quality of the replaceable units) as much as possible.

For example, Japanese Laid-open Patent Application No. 2002-333800 discloses a technology to realize this request of the manufacturer. Japanese Laid-open Patent Application No. 2002-333800 discloses that identification information is recorded to a consumable component beforehand and an image forming apparatus using the consumable component determines to conduct an image formation if the identification information is identical to identification information registered beforehand. Therefore, by using this technology, it can be concerned to prevented from using units (components) other than the authentic units by allowing the image formation only when the identification information recorded to the consumable component is identical the identification information of the authentic unit.

However, in a case of applying this configuration, if the identification information registered beforehand in the apparatus is analyzed, the same identification information can be easily recorded to a unit. Disadvantageously, if a supplier of the non-authentic unit records the same identification information to the non-authentic unit, the apparatus cannot distinguish between the authentic unit and the non-authentic unit.

Moreover, even if a unit is the non-authentic unit, the unit does not always have a quality problem. The unit may have a quality equal to the authentic unit. In a case of using the unit which may have the quality equal to the authentic unit, if the operation of the apparatus is set to be disabled by reason of the non-authentic unit, options of a user of the apparatus are restricted and it is not a appropriate means.

### SUMMARY OF THE INVENTION

It is a general object of the present invention to provide electronic apparatuses, image forming apparatuses, methods for controlling electronic apparatus, and systems for managing image forming apparatus, in which the above-mentioned problems are eliminated.

A more specific object of the present invention is to provide an electronic apparatus, an image forming apparatus, a method for controlling electronic apparatus, and a system for managing image forming apparatus, in which even in an environment distributing non-authentic components in market, it is possible to prevent the liability with respect to the apparatus degrade from degrading because of problems of the non-authentic components and to attempt a user to use the authentic components.

The above objects of the present invention are achieved by an electronic apparatus capable of using a component recording a digital certificate, including: an obtaining part obtaining the digital certificate recorded in the component; an authenticating part authenticating the component by using the digital certificate; and a controlling part controlling an operation of the electronic apparatus based on an authentication result by the authenticating part.

In the electronic apparatus, the component may be a replaceable consumable component.

Moreover, the electronic apparatus may include a part informing an authentication result by the authenticating part.

Furthermore, in the electronic apparatus, the digital certificate may be information concerning the component and shows information unnecessary to rewrite.

Moreover, in the electronic apparatus, the information unnecessary to rewrite may be type information showing a type of the component.

Furthermore, the electronic apparatus may include a communicating part communicating with the component being used in the electronic apparatus, wherein the communicating part sends and receives information necessary to rewrite in information which the component records or is recorded by the component, through an encrypted communication path in which contents are encrypted by using the digital certificate and sends and receives the contents being encrypted.

Moreover, the electronic apparatus may include a controlling part controlling an operation of the electronic apparatus in accordance with control information received from the component through the encrypted communication path.

Furthermore, In the electronic apparatus, the component is a toner supplying member; and the electronic apparatus is an image forming apparatus comprising: an image forming part forming an image onto a sheet by using a toner supplied from the toner supplying member; and a second communicating part communicating with a managing apparatus being externally arranged, wherein the controlling part includes a part obtaining information showing a toner residual quantity as from the toner supplying member as the control information, and ordering another toner supplying member for a replacement to the managing apparatus by the second communicating part.

Moreover, in the electronic apparatus, the digital certificate which the member records may be a certificate which validity can be confirmed by using a certificate key special for authenticating the component.

Furthermore, in the electronic apparatus, the component may include an operating part, and a communicating part communicating with a main device of the electronic apparatus; and the main device of the electronic apparatus may include a recording part recording the digital certificate, wherein a mutual authentication is conducted by using the digital certificate of the component being recorded in the electronic apparatus and the digital certificate of the electronic apparatus being recorded in the component, by the operating part and the authenticating part.

Moreover, the above objects of the present invention are achieved by a method for controlling an electronic apparatus using a component recording a digital certificate, the method including the steps of: (a) obtaining the digital certificate being recorded in the component; and (b) authenticating the component by using the digital certificate, wherein an operation of the electronic apparatus is controlled based on an authentication result in the step (a).

In the method, the component may be a replaceable consumable component.

Moreover, in the method, the authentication result in the step (b) may be informed to the electronic apparatus.

Furthermore, in the method, the digital certificate includes information unnecessary to rewrite in that the information may be information concerning the component.

Moreover, the method may further includes the step of (c) communicating with the component in the electronic apparatus in that the electronic apparatus is caused to execute the step (c), wherein in the step (c), information necessary to rewrite in information, which the component records or is recorded by the component, is sent and received through an encrypted communication path in which contents are encrypted by using the digital certificate and sends and receive the contents being encrypted.

Furthermore, in the method, the electronic apparatus may control an operation of the electronic apparatus itself in accordance with control information received from the component through the encrypted communication path.

Moreover, in the method, the digital certificate may be recorded in the electronic apparatus, and in the step (b), a mutual authentication may be conducted by using the digital certificate of the component being recorded in the electronic apparatus and the digital certificate of the electronic apparatus being recorded in the component.

Furthermore, the above objects of the present invention are achieved by a computer-readable recording medium recorded with a program for causing a computer to control an electronic apparatus using a component recording a digital certificate, the program including the codes for: (a) obtaining the digital certificate being recorded in the component; and (b) authenticating the component by using the digital certificate, wherein an operation of the electronic apparatus is controlled based on an authentication result by the code (a).

In the computer-readable recording medium, the component may be a replaceable consumable component.

Moreover, in the computer-readable recording medium, the authentication result by the code (b) may be informed to the electronic apparatus.

Furthermore, in the computer-readable recording medium, the digital certificate may include information unnecessary to rewrite in that the information is information concerning the component.

Moreover, the computer-readable recording medium may further include the code for (c) communicating with the component in the electronic apparatus in that the electronic apparatus is caused to execute the code (c), wherein by the code (c), information necessary to rewrite in information, which the component records or is recorded by the component, is sent and received through an encrypted communication path in which contents are encrypted by using the digital certificate and sends and receive the contents being encrypted.

Furthermore, in the computer-readable recording medium, an operation of the electronic apparatus may be controlled in accordance with control information received from the component through the encrypted communication path.

Moreover, the computer-readable recording medium may further include the codes for recoding the digital certificate, wherein by the code (b), a mutual authentication is conducted by using the digital certificate of the component being recorded in the electronic apparatus and the digital certificate of the electronic apparatus being recorded in the component.

Moreover, the above objects of the present invention can be achieved by a program for causing a computer to conduct processes described above.

Furthermore, the above objects of the present invention are achieved by an image forming apparatus managing system, including: an image forming apparatus, including: an obtaining part obtaining a digital certificate recorded in a component; an authenticating part authenticating the component by using the digital certificate; a controlling part controlling an operation of the image forming apparatus based on an authentication result by the authenticating part; a communicating part communicating with the component being used in the image forming apparatus, wherein the communicating part sends and receives information necessary to rewrite in information which the component records or is recorded by the component, through an encrypted communication path in which contents are encrypted by using the digital certificate and sends and receives the contents being encrypted; a controlling part controlling an operation of the image forming apparatus in accordance with control information received from the component through the encrypted communication path; a toner supplying member as the component; an image forming part forming an image onto a sheet by using a toner supplied from the toner supplying member; and a second communicating part communicating with a managing apparatus being externally arranged, wherein the controlling part includes a part obtaining information showing a toner residual quantity as from the toner supplying member as the control information, and ordering another toner supplying member for a replacement to the managing apparatus by the second communicating part, and a managing apparatus for managing the image forming apparatus, wherein the managing apparatus includes a receiving part receiving an order of the toner supplying member for a replaceable from the image forming apparatus.

Moreover, the above objects of the present invention are achieved by a component capable of recording a digital certificate, comprising a record area recording the digital certificate, which validity can be confirmed by using a certificate key being recorded in an electronic apparatus using the component.

In the component, the component may be used as a replaceable consumable component in the electronic apparatus.

Moreover, in the component, the digital certificate may be information concerning the component and includes information unnecessary to rewrite.

Furthermore, in the component, the information unnecessary to rewrite is type information showing a type of the components.

Moreover, the component may further include a communicating part communicating with the electronic apparatus using the component, wherein the communicating part sends and receives the information unnecessary to rewrite in the information being recorded in the component, through an encrypted communication path in which contents are encrypted by using the digital certificated being recorded in the component.

Furthermore, in the component, the digital certificate being recorded in the component may be a digital certificate which validity can be confirmed by using a certificate key special for authenticating the component.

Moreover, the component may further include a communicating part communicating with the electronic apparatus using the component; and an authenticating part obtaining a digital certificate from the electronic apparatus and authenticating the electronic apparatus by using the digital certificate.

### BRIEF DESCRIPTION OF THE DRAWINGS

In the following, embodiments of the present invention will be described with reference to the accompanying drawings.

FIG. 1 is a diagram showing a hardware configuration of the entire electronic apparatus according to a first embodiment of the present invention;

FIG. 2 is a diagram briefly showing the hardware configuration shown in FIG. 1, according to the first embodiment of the present invention;

FIG. 3A is a diagram showing certificates and keys recorded in NVRAMs according to the first embodiment of the present invention, and FIG. 3B is a diagram showing the certificates and the keys recorded in the NVRAMs according to the first embodiment of the present invention;

FIG. 4A is a diagram for explaining relationships among a public key certificate, a private key, and a root key certificate used for an authentication process according to the first embodiment of the present invention, and FIG. 4B is a diagram for explaining the relationships among the public key certificate, the private key, and the root key certificate used for the authentication process according to the first embodiment of the present invention;

FIG. 5A is a diagram showing a data structure of a component public key certificate according to the first embodiment of the present invention, and FIG. 5B is a diagram showing a data structure of a device public key certificate according to the first embodiment of the present invention;

FIG. 6 is a flowchart for explaining a process conducted when a CPU of a main device is activated in an electronic apparatus according to the first embodiment of the present invention;

FIG. 7 is a diagram showing an example of a warding display conducted in step S4 in FIG. 6, according to the first embodiment of the present invention;

FIG. 8 is a flowchart for explaining the authentication process conducted in step S2 in FIG. 6 in detail, according to the first embodiment of the present invention;

FIG. 9 is a flowchart for explaining a variation of the authentication process shown in FIG. 8, according to the first embodiment of the present invention;

FIG. 10 is a diagram showing a variation of the component public key certificate according to the first embodiment of the present invention;

FIG. 11A is a diagram showing digital certificates and a key recorded in the component according to the first embodiment of the present invention, and FIG. 11B is a diagram showing digital certificates and a key recorded in the main device according to the first embodiment of the present invention;

FIG. 12A is a diagram showing another variation of the component public key certificate according to the first embodiment of the present invention; and FIG. 12B is a diagram showing still another variation of the component public key certificate according to the first embodiment of the present invention;

FIG. 13 is a diagram briefly showing a configuration according to a second embodiment of the present invention;

FIG. 14 is a flowchart for explaining an authentication process according to the second embodiment of the present invention;

FIG. 15 is a diagram showing a configuration of an image forming apparatus managing system according to a third embodiment of the present invention;

FIG. 16A is a schematic diagram showing a data transmission model for sending an operation request and receiving an operation response according to the third embodiment of the present invention, and FIG. 16B is a schematic diagram showing the data transmission model for sending the operation request and receiving the operation response according to the third embodiment of the present invention;

FIG. 17 is a cross sectional view showing a typical entire configuration of the image forming apparatus, according to the third embodiment of the present invention;

FIG. 18 is a cross sectional view showing a process cartridge being in a brand-new state according to the third embodiment of the present invention;

FIG. 19 is a cross sectional view showing a typical peripheral state in a case in that the process cartridge is arranged at an arrangement position in the image forming apparatus according to the third embodiment of the present invention;

FIG. 20 is a block diagram mainly showing the hardware configuration related to a control and a communication of the image forming apparatus according to the third embodiment of the present invention;

FIG. 21 is a block diagram showing one example of a software configuration of the image forming apparatus according to the third embodiment of the present invention;

FIG. 22 is a block diagram showing an internal configuration of an NRS application according to the third embodiment of the present invention;

FIG. 23 is a block diagram showing a hardware configuration of each part related to the authentication process and a warning according to the third embodiment of the present invention;

FIG. 24 is a block diagram showing a brief hardware configuration concerning a mutual authentication conducted between a controller and the process cartridge, according to the third embodiment of the present invention;

FIG. 25 is a block diagram showing a brief hardware configuration of the managing apparatus according to the third embodiment of the present invention;

FIG. 26 is a diagram partially showing a type and a format of data to record in the NVRAM of the process cartridge in the image forming apparatus shown in FIG. 15, according to the third embodiment of the present invention;

FIG. 27 is a flowchart for explaining processes executed by a CPU of the process cartridge and a CPU of a controller in response to an automatic order of a toner cartridge for a replacement in the image forming apparatus shown in FIG. 15, according to the third embodiment of the present invention;

FIG. 28 is a diagram showing an example of an operation sequence when the processes shown in FIG. 27 are conducted, according to the third embodiment of the present invention;

FIG. 29 is a diagram showing a supply call screen displayed in step S307 in FIG. 28, according to the present invention;

FIG. 30 is a diagram showing a description example of a SOAP request concerning the supply call send in step S308 in FIG. 28, according to the third embodiment of the present invention;

FIG. 31 is a diagram showing a structure of data included in a body part of the SOAP request shown in FIG. 30, according to the third embodiment of the present invention;

FIG. 32 is a block diagram showing another configuration of a remote management system shown in FIG. 15, according to the third embodiment of the present invention;

FIG. 33 is a diagram showing a type and a format of data recorded in the NVRAM of the component used in a management subject apparatus included in the remote management system shown in FIG. 32, according to the third embodiment of the present invention.

### DESCRIPTION OF THE PREFERRED EMBODIMENT

In the following, an embodiment of the present invention will be described with reference to the accompanying drawings.

### First Embodiment

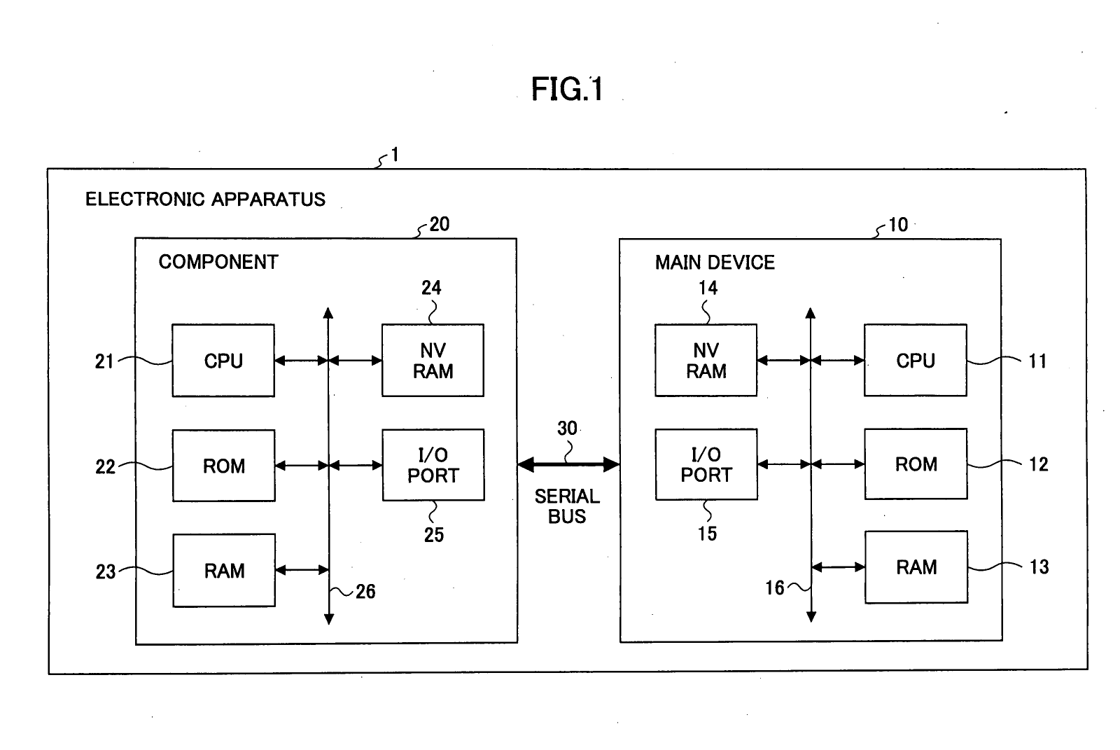

First, an electronic apparatus according to a first embodiment will be described with reference to FIG. 1 through FIG. 9. FIG. 1 is a diagram showing a hardware configuration of the entire electronic apparatus according to the first embodiment of the present invention.

As shown in FIG. 1, the electronic apparatus 1 includes a main device 10, and a component 20, which are mutually connected via a bus 30. The component 20 is a detachable part to be replaceable independently of the main device, and records a digital certificate.

Moreover, in the electronic apparatus 1, when the electronic apparatus 1 is activated by a power ON or a reset, an authentication process using a PKI (Public Key Infrastructure) is conducted between the main device 10 and the component 20, and a warning is issued when authentication is failed.

The main device 10 includes a CPU (Central Processing Unit) 11, a ROM (Read-Only Memory) 12, a RAM (Random Access Memory) 13, an NVRAM (Non-Volatile RAM) 14, and an I/O (Input/Output) port 15, which are mutually connected via a internal bus 16. Then, the CPU 11 conducts each function of parts including an obtaining part, an authenticating part, a controlling part, and a like by executing programs stored in the ROM 12 and the NVRAM 14, and conducts a process concerning a data transmission among the parts.

The NVRAM 14 is a recording part and records the digital certificate and a key used for the authentication process. The I/O port 15 is an interface to connect the main device 10 to the bus 30, and functions as a communication part with the CPU 11. In addition, if necessary, an interface is provided to connect the electronic apparatus 1 to a network such as a LAN (Local Area Network).

On the other hand, the component 20 includes a CPU 21, a ROM 22, a RAM 23, an NVRAM 24, and an I/O port 25, which are mutually connected via an internal bus 26. The NVRAM 24 records the digital certificate and a key used for the authentication process. The CPU 21 executes programs recorded in the ROM 22 and the NVRAM 24, so that a control and a data management of the component 20 and a data transmission and the authentication process with the main device 10 are conducted. That is, the CPU 21 functions as a communicating part and a computing part. Each part may be provided by a control chip or may be provided on a socket used to connect the component 20 to the main device 10.

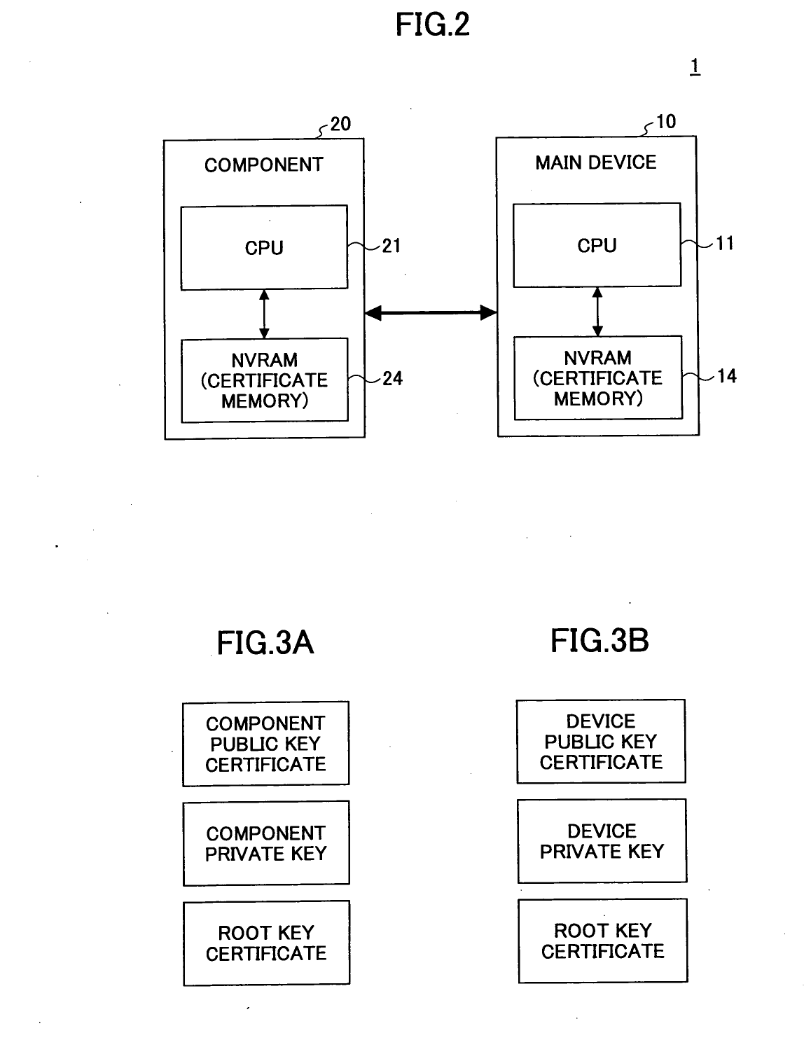

Therefore, in a case in that the main device 10 and the component 20 mutually authenticate in the hardware configuration shown in FIG. 1, a brief configuration concerning to this case is shown in FIG. 2. FIG. 2 is a diagram briefly showing the hardware configuration shown in FIG. 1, according to the first embodiment of the present invention.

That is, the CPU 11 of the main device 10 read out the digital certificate and the key of the main device 10, which are necessary to conduct the authentication process, from the NVRAM 14 functioning a certificate memory.

Moreover, the CPU 21 of the component 20 reads out the digital certificate and the key of the component 20 necessary for the authentication process from the NVRAM 24 functioning as a certificate memory. Next, a communication is conducted between the CPU 11 and the CPU 21, and the authentication process is conducted by using these digital certificates and the keys. In this case, the CPU 11, CPU 21, and buses and interfaces between the CPU 11 and CPU 21 correspond to communication parts.

Other parts shown in FIG. 1 are auxiliary related to the authentication process. Thus, configurations of the main device 10 and the component 20 shown in FIG. 2 are assumed in the following.

In addition, for the sake of convenience, in the following (including other embodiments), only the configuration and processes concerning a case of a single component 20 for the authentication will be described. In a case of providing a plurality of components 20, other components 20 have the same configuration and the same processes are conducted between each of the components 20 and the main device 10 in parallel or serial.

Next, the certificates and the keys recorded in the NCVRAMs 14 and 24 to use for the authentication process will be described. FIG. 3A and FIG. 3B show the certificates and the keys recorded in the NVRAMs according to the first embodiment of the present invention.

In the electronic apparatus 1, a component public key certificate and component private key and a root key certificate are recorded in the NVRAM 24 of the component 20 as shown in FIG. 3A, and a device public key certificate, a device private key, and a root key certificate are recorded in the NVRAM 14 as shown in FIG. 3B.

These certificates are public key certificates, private keys, and root key certificates concerning a public key encryption. The private key (each of the device private key and the component private key) is a key issued from a certificate authority (CA) to each of devices (the electronic apparatus 1 or the main device 10 in this case) or the component (the component 20 in this case). The public key certificate is the digital certificate in which the certificate authority executes a digital signature to the public key corresponding to the private key. The root key certificate is the digital certificate in which the certificate authority executes the digital signature to the root key corresponding to the root private key used for the digital signature.

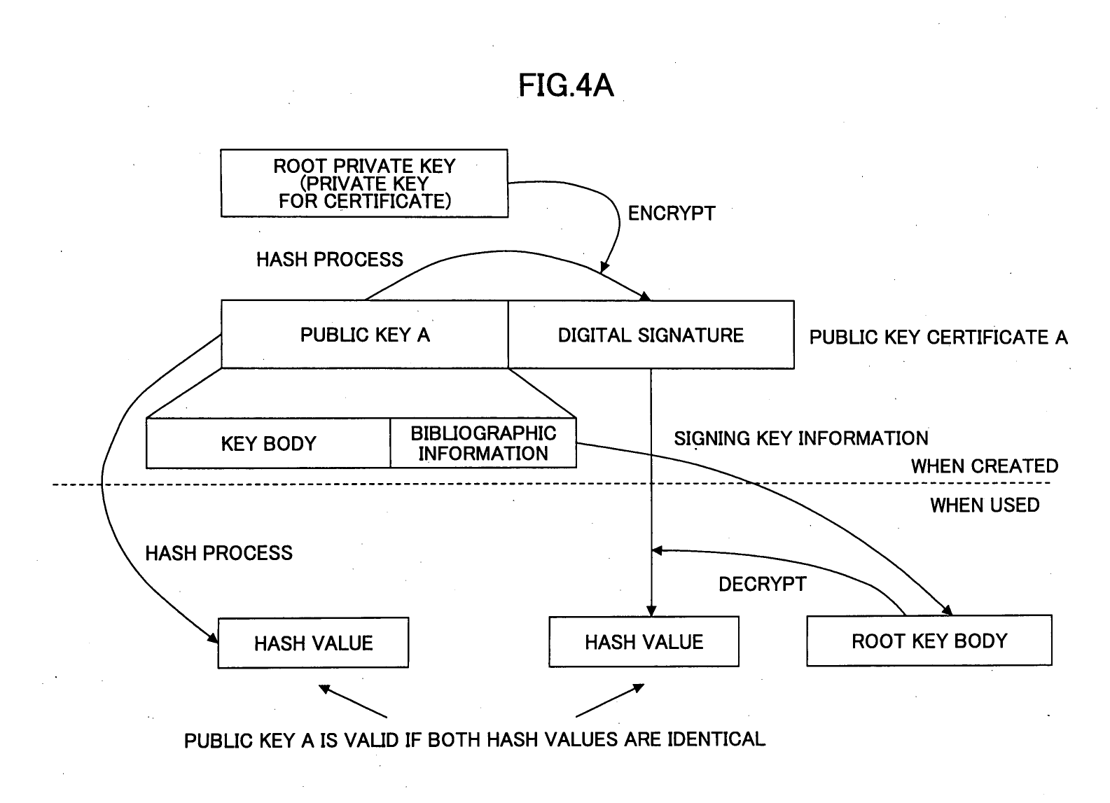

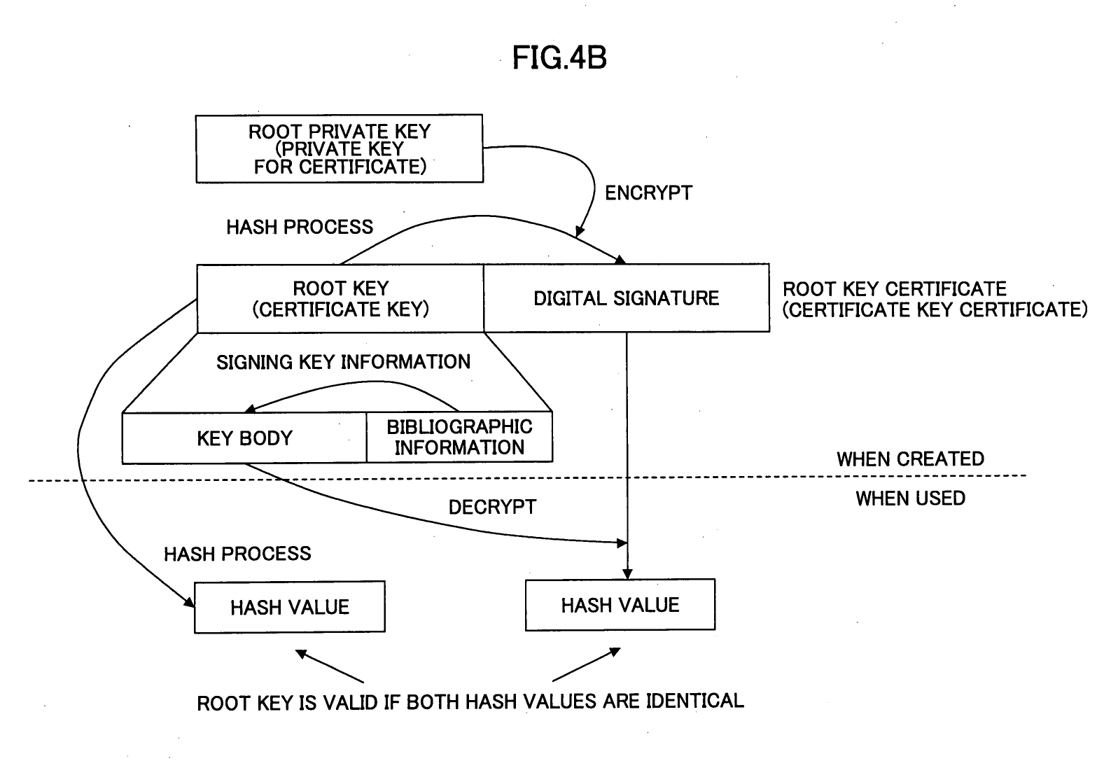

FIG. 4A and FIG. 4B are diagrams for explaining relationships among the public key certificate, the private key, and the root key certificate used for the authentication process according to the first embodiment of the present invention.

As shown in FIG. 4A, for example, a public key A includes a key body to decrypt a document being encrypted by using a private key A corresponding to the public key, and bibliographic information including information showing an issuer (certificate authority) of the public key A, an expiration date, and a like. In order to show that the key body and the bibliographic information are not falsified, a hash value obtained by conducting a hash process to the public key A is encrypted by using the root private key and attached to the public key A as the digital signature. In this case, identification information of the root private key to use for the digital signature is additionally provided to the bibliographic information of the public key A as signing key information. A public key certificate attaching this digital signature is a public key certificate A.

In a case of using the public key certificate A, the digital signature included in the public key certificate A is decrypted by using the key body of the root key as the public key corresponding to the root private key. When this decryption is normally conducted, the digital signature is surely provided by the certificate authority. Moreover, when a hash value obtained by conducting the hash process for the public key A is identical to a hash value obtained by the decryption, it shows that the key itself is not damaged and is not falsified. Furthermore, when data being received is normally decrypted by using this public key A, it shows that the data is sent from an owner possessing the private key A.

For example, a public key certificate A as described above can be created in accordance with a format being compliant with X.509 but is not limited to this format.

In order to conduct the authentication, it is needed to record the root key beforehand. As shown in FIG. 4B, the root key is recorded as the root key certificate in which the certificate authority provides the digital signature. The root key certificate is a format capable of decrypting the digital signature by the public key included in the root key itself. When the root key is used, the digital signature is decrypted by using the key body included in the root key certificate, and the hash value is compared with another hash value obtained by conducting the hash process to the root key. When the hash value is identical to another hash value, it shows that the root key is not damaged.

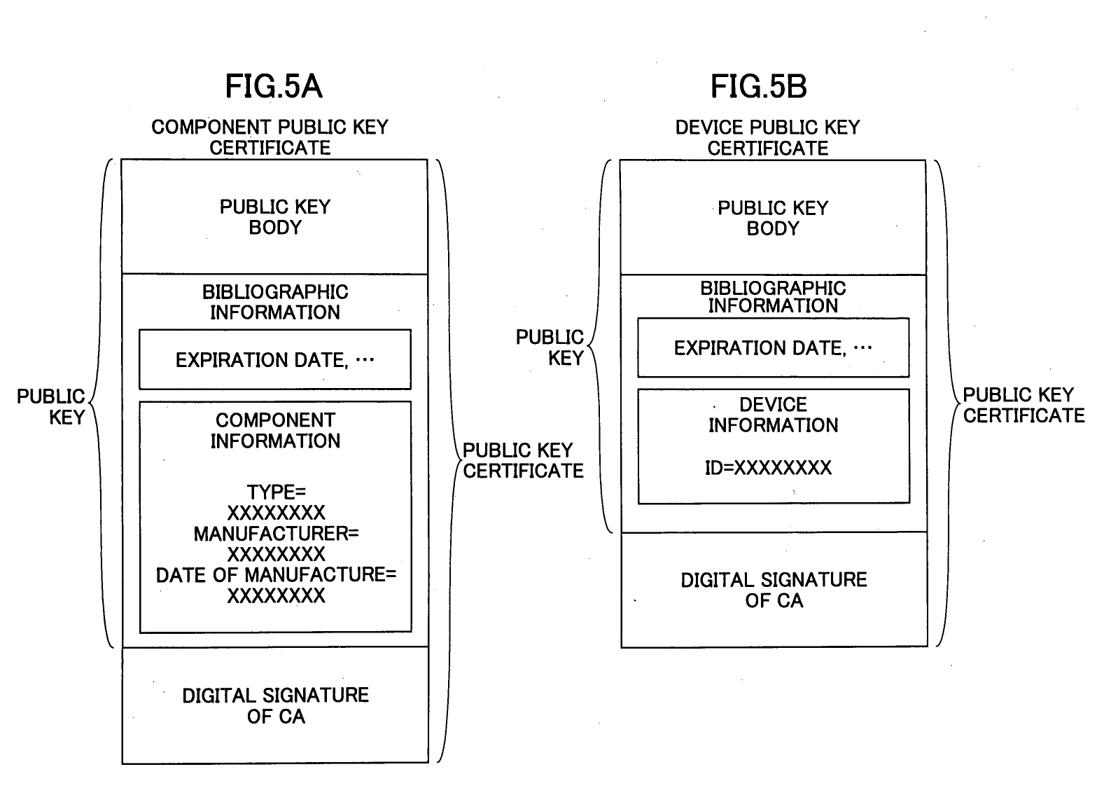

Next, information to be described in the component public key certificate and the public key certificate will be described with reference to FIG. SA and FIG. 5B. FIG. 5A is a diagram showing a data structure of the component public key certificate according to the first embodiment of the present invention and FIG. 5B is a diagram showing a data structure of the device public key certificate according to the first embodiment of the present invention.

As shown in FIG. 5A, for the component public key certificate, an expiration date of the public key certificate, and component information including a type, a manufacturer, a date of manufacture, and a like of the consumable component as information concerning the component of a subject to issue the public key are recorded in the bibliographic information. Since the bibliographic information is not needed to rewrite, the bibliographic information is described within the public key to prevent it from being falsified. The type of the component may be a brief category such as “process cartridge”, version information may be additionally provided, or a product number may be described, so as to show details.

In addition, other information that is information concerning the component and is not needed to rewrite may be described within the bibliographic information. Identification information identifying the component 20 such as a serial number, and a like may be described within the bibliographic information.

As shown in FIG. 5B, in the public key certificate, the expiration date of the public key certificate, and an ID (serial number, or a like) such as identification information of the main device 10 as information concerning the main device 10 that is a subject to issue the public key, are recorded within the bibliographic information. Accordingly, a different public key certificate is recorded for each device or each component. Alternatively, instead of recording information for identifying each device or each component, for example, an identical public key certificate may be recorded for all devices or all components having a special function (for example, color image forming device or a like).

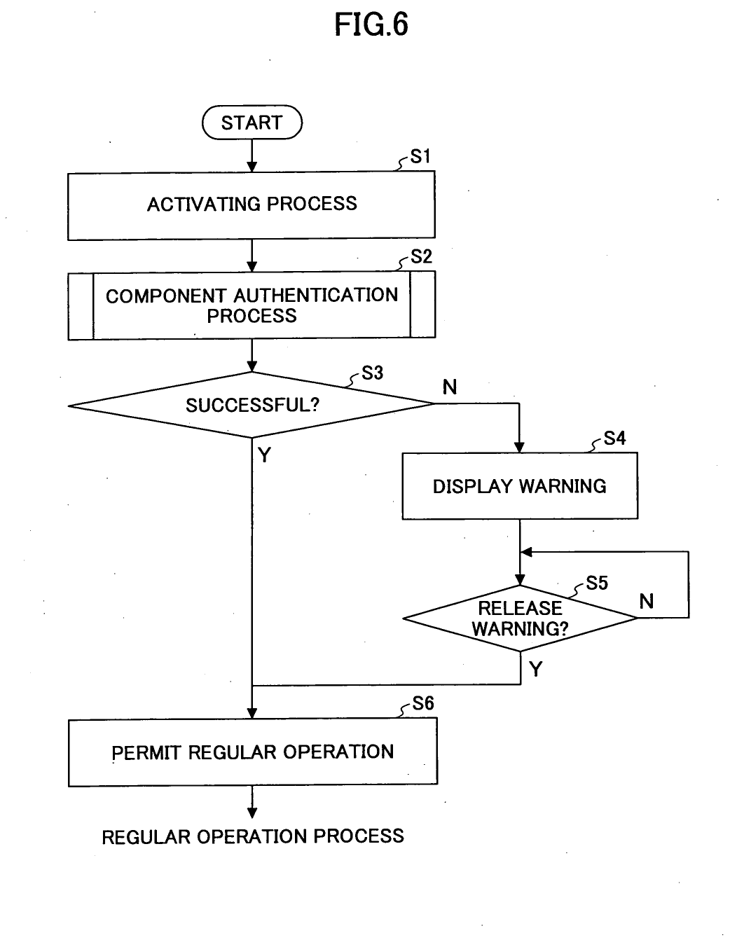

Next, a process conducted when the CPU 11 of the main device 10 is activated in the electronic apparatus 1 will be described with reference to FIG. 6. FIG. 6 is a flowchart for explaining the process conducted when the CPU of the main device is activated in the electronic apparatus according to the first embodiment of the present invention.

In the electronic apparatus 1, in a case of conducting an activating process for activating the electronic apparatus 1 by a power ON or a reset, the CPU 11 of the main device 10 starts the process in accordance with the flowchart shown in FIG. 6 by executing a predetermined control program.

In this process, first, a general activating process is conducted such as an initialization, transition toward an operative state, and a like for each processing part in step Si. If the component 20 is not mounted, an error occurs at this step Si.

After that, in step S2, the authentication process of the component 20 is conducted by using the certificate and the key described with reference to FIG. 3 and FIG. 5. Details of the authentication process of the component 20 will be described later. The authentication in step S2 succeeds when the component 20 is an authentic component. On the other hand, the authentication fails when the component 20 is a non-authentic component. The authentication process corresponds to a step of obtaining the digital certificate and a step of authenticating the component, and the CPU 11 functions as an obtaining part and an authenticating part.

Referring to FIG. 6, next, in step S3, it is determined whether or not the authentication of the component 20 is successful in the authentication process conducted in step S2. Then, when the authentication is successful, the component 20 is the authentic component and then the process can be continued. Accordingly, a regular operation of the electronic apparatus 1 is allowed, and the process transits to a regular operation process for controlling each regular operation of processing parts in the electronic apparatus 1.

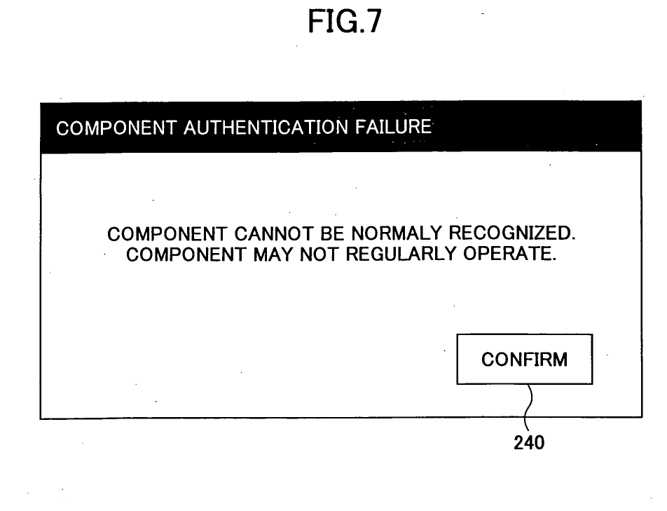

On the other hand, when the authentication fails in step S3, since the component 20 is not the authentic component and a quality of the component 20 may not be sufficient, a warning is displayed at an appropriate display unit (for example, a display mounted in the electronic apparatus 1) in step S4. For example, a display screen as shown in FIG. 7 may be displayed at the electronic apparatus 1. In addition, this displaying process corresponding to a step of issuing a warning and the CPU 11 and an operating part 209 function as a warning part that will be described later.

When a user presses a “CONFIRM” key 240 in the display screen shown in FIG. 7 or when a predetermined time passes, it is determined in step S5 that it is a timing of releasing the warning, and the process advances to step S6 to allow continuing the regular operation after this. In step S6, the display screen is returned to be a regular screen at the display unit.

That is, in steps S3 through S5, an operation of the electronic apparatus 1 is controlled based on an authentication result of the authentication process.

By conducting the above-described process, when it is determined that the component 20 is not the authentic component, it is possible to issue the warning showing that the electronic apparatus 1 may not normally operate. In addition, since the digital certificate is used to authenticate the component 20, it is possible to detect that information concerning the type, a manufacture name, and a like of the component 20 is falsified. Accordingly, it is possible to distinguish a component being the non-authentic component.

Accordingly, there is rare case in that the user convinces himself/herself that the component 20 being actually the non-authentic component is the authentic component to use, the user easily understands the a problem is caused by the component 20 when the problem occurs because of the non-authentic component (for example, an image quality is degraded in a case of the image forming apparatus). Therefore, it is possible to prevent the liability of the main device 10 from being degraded. Moreover, it is possible to urge the user who places much value on the quality to select the authentic component. Therefore, it is possible to urge the user to use a component which quality can be managed by a supplier of the main device 10. Then, since the manufacturer can sufficiently adjust characteristics of the authentic component to be suitable for the main device 10, the user can have an advantage of using the authentic component from a viewpoint of obtaining a high operation quality.

The warning can be conducted with a warning sound, an audio guidance, lighting or blinking of a light source, or a like in addition to, or instead of the display screen showing a warning message. Moreover, other than the warning, any means for informing an authentication result from the authentication process can be applied.

Moreover, it is not limited to conduct the authentication process immediately after the activating process, the authentication process can be conducted at arbitrary timing.

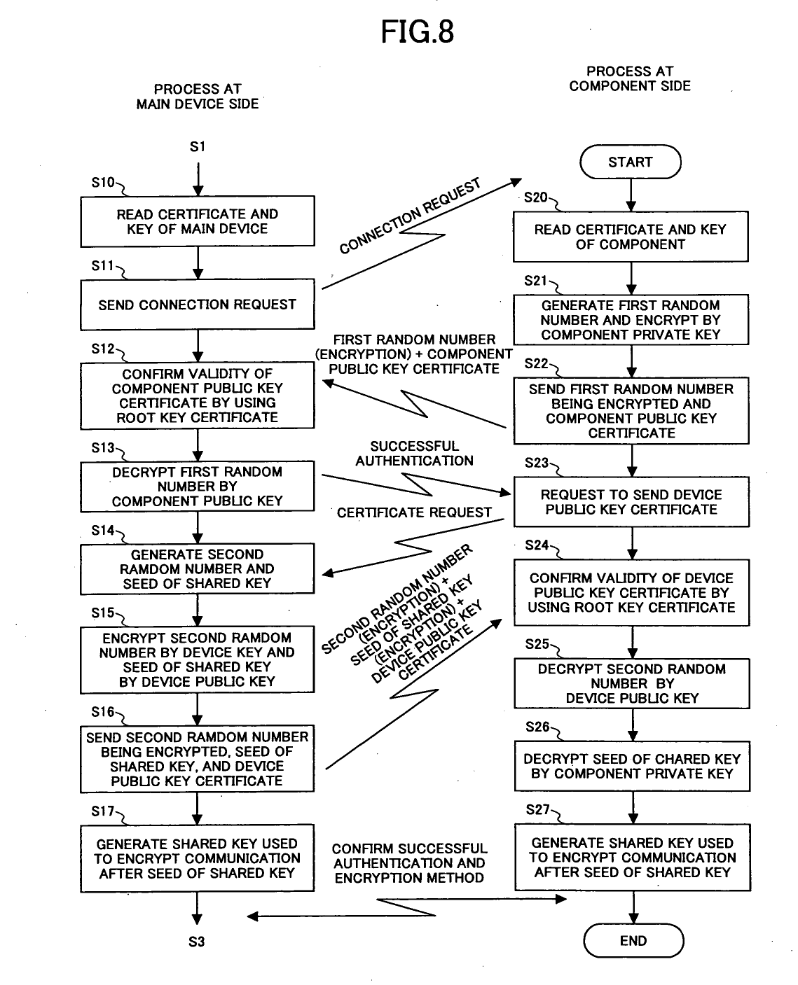

FIG. 8 is a flowchart for explaining the authentication process conducted in step S2 in FIG. 6 in detail, according to the first embodiment of the present invention. In FIG. 8, arrows between two processes at a main device side and a component side show data transmissions. a data transmission process is conducted at a sender side being a source of an arrow, and a process in step being pointed by a forefront of the arrow is conducted at a receiver side when the receiver side receives information from the sender side. Moreover, when a process in each step not normally end, a response showing a failure of the authentication is sent to the sender, the process in that step is halted, and the process conducted when the CPU of the main device 10 is activated in the electronic apparatus advances to step S3 shown in FIG. 6. Also, in a case of receiving the response showing the authentication failure and a case of a timeout, the process conducted when the CPU of the main device 10 is activated in the electronic apparatus advances to step S3 shown in FIG. 6.

In step S2 in FIG. 6, the CPU 11 of the main device 10 conducts the process at the main device side in accordance with steps S10 through S17 shown at a right side in FIG. 8. First, in step S10, the CPU 11 reads out the device public key certificate, the root key certificate, and the key of the main device 10 from the NVRAM 14, and sends a connection request to the component 20 in step S11.

On the other hand, when the CPU 21 of the component 20 receives the connection request from the main device 10, the CPU 21 starts the process at the component side in accordance with steps S20 through S27 shown at a right side in FIG. 8. The CPU 21 reads out the component public key certificate, the root key certificate, and the component private key of the component 20 from the NVRAM 24 in step S20, and generates a first random number to encrypt the first random number by the component private key in step S21. Subsequently, the CPU 21 sends the first random number being encrypted and the component public key certificate to the main device 10 in step S22.

At the main device side, when the main device 10 receives the first random number being encrypted and the component public key certificate from the component 20, the CPU 11 checks a validity of the component public key certificate by using the root key certificate in step S12. In step S10, the CPU 11 not only checks whether or not the component public key certificate is damaged or falsified but also refers to the bibliographic information included in the component public key to compare with information recorded at the main device side so as to confirm that the component 20 is a suitable component to use for the electronic apparatus 1 (or the main device 10), and so as to confirm that the component 20 is the authentic component or a suitable type for the electronic apparatus 1 (or the main device 10).

In a case in which the component 20 is not the authentic component, since an appropriate public key certificate cannot be recorded, the authentication process fails in step S12. On the other hand, when the component 20 is the authentic component, since the appropriate public key certificate can be recorded, the authentication process is successfully conducted if the user does not mount a wrong component to the electronic apparatus 1.

When the CPU 11 confirms a validity of the component public key certificate by using the root key certificate in step S12, in step S13, the CPU 11 decrypts the first random number by using a component public key included in the component public key certificate received from the component 20. When this decryption is successful, it can be confirmed that the first random number is surely received from a subject to which the component public key certificate is issued. In this case, the CPU 11 sends information showing that the authentication is successful, to the component 20.

When the component 20 receives the information showing that the authentication is successful, the CPU 20 of the component 20 sends a certificate request for requesting the public key certificate for the authentication, to the main device 10 in step S23.

In response to the certificate request, the CPU 11 of the main device 10 generates a second random number and a seed of a shared key in step S14. For example, the seed of the shared key can be generated based on data exchanged by the data transmission with the component 20. Subsequently, in step S15, the CPU 11 encrypts the second random number by using the device private key and encrypts a third random number by using the component public key in step S15, and then the CPU 11 sends the second random number being encrypted and the third random number being encrypted with the public key certificate to the component 20 in step S16. The third random number is encrypted so that a subject other than the component 20 cannot recognize the third random number.

When the component 20 receives the second random number being encrypted and the third random number being encrypted with the public key certificate, the CPU 21 checks a validity of the public key certificate by using the root key certificate in step S24. Similar to step S12, a process for confirming that the electronic apparatus 1 (or the main device 10) is an apparatus (or a device) suitable for the component 20 may be included in step S24.

When the CPU 21 confirms the validity of the public key certificate by using the root key certificate, the CPU 21 decrypts the second random number by using the device public key included in the public key certificate being received from the electronic apparatus 1 in step S25. When this decryption is successful, it can be confirmed that the second random number is surely received from a subject to which the device public key certificate is issued.

After that, the CPU 21 decrypts the seed of the shared key by using the component private key in step S26. By conducting the above-described processes, the shared key is shared with both the main device 10 and the component 20. In addition, at least the seed of the shared key cannot be recognized by other than the main device 10 which generated the seed of the shared key and the component 20 possessing the component private key. The above-described processes until step S26 are successfully conducted, the CPU 21 of the component 20 generates the shared key used to encrypt a further communication, from the seed of the shared key obtained by the decryption conducted in step S27.

When the CPU 11 ends a process in step S17 at the main device side and the CPU 21 ends a process in step S27 at the component side, the main device 10 and the component 20 mutually confirm the successful authentication and an encryption method used for further communications, determine to communication to each other by the encryption method for the further communication, and then terminate the authentication process. While the main device 10 and the component 20 mutually confirm as described above, the component 20 sends a response showing that the authentication succeeds. Since a communication is established between the main device 10 and the component 20 after the steps S1 through S17 at the main device 10 and the steps S20 through S27 at the component 20, the main device 10 and the component 20 can communication to each other by encrypting data in accordance with a shared key encryption method by using the shared keys generated in step S17 and step S27, respectively.

By conducting the above-described processes, the main device 10 and the component 20 can safely possess the shared key. Therefore, it is possible to establish a safe communication path in that a communication is encrypted by using the digital certificate.

In FIG. 8, the authentications mutually conducted by the main device 10 and the component 10 using the digital certificates recorded at the main device side and the component side, respectively, are illustrated. However, it should be noted that it is not mandatory to encrypt the second random number by using the device public key and to send the public key certificate to the component 20.

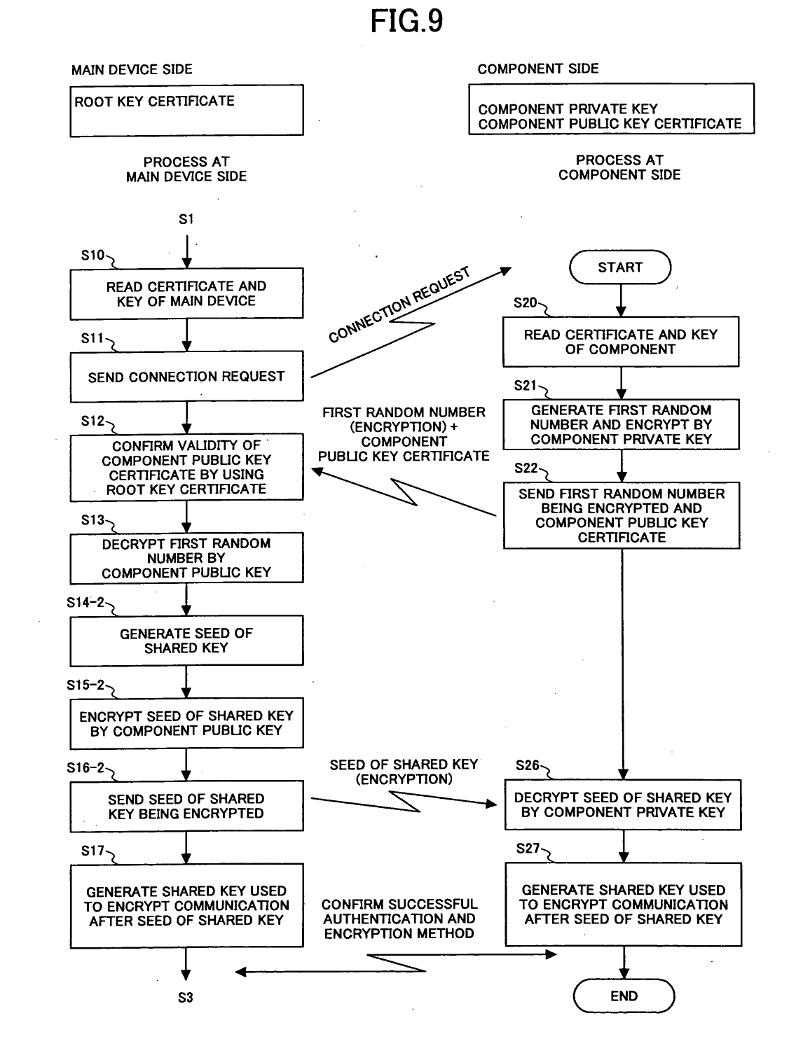

In this case, the steps S23 and S24 conducted at the component side can be omitted, and the processes will be as shown in FIG. 9. FIG. 9 is a flowchart for explaining a variation of the authentication process shown in FIG. 8, according to the first embodiment of the present invention. In the flowchart shown in FIG. 9, the component 20 cannot authenticate the main device 10. However, the processes shown in FIG. 9 are sufficient for a case in that only the main device 10 authenticates the component 20. In this case, only the root key certificate is recorded in the main device 10, and the device private key and the device public key certificate are not required. In addition, it is not required to record the root key certificate in the component 20.

The digital certificates used for the authentication process as described above are not limited to those shown in FIG. 3A, FIG. 3B, FIG. 5A, and FIG. 5B.

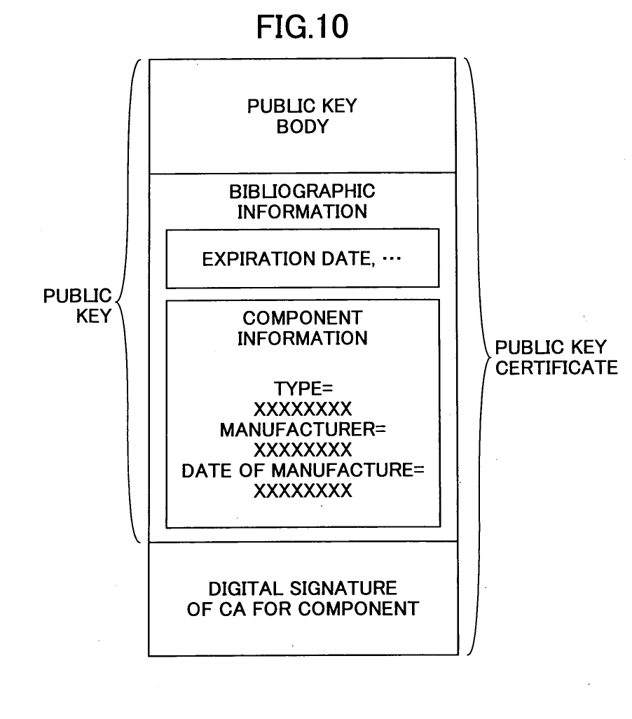

For example, the public key for the component 20 may be issued by a special certificate authority for components. In this case, as shown in FIG. 10, since the digital signature to attach to the public key is provided to the special certificate authority, a special root key certificate for a component authentication is used to confirm the validity of the public key.

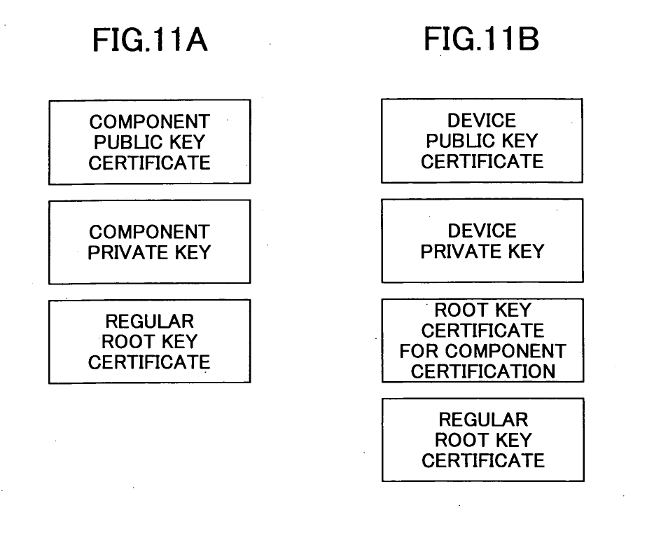

That is, as shown in FIG. 11A and FIG. 11B, in addition to a regular root key certificate used to communicate with other devices, a root key certificate for the component authentication is recorded as the special root key certificate to authenticate the component 20 within the main device 10. When the authentication process is conducted as shown in FIG. 8 and FIG. 9, the root key certificate for the component authentication is used.

In this variation, it is possible to confirm the validity of the public key certificate received from the component 20 by using the root key certificate for the component authentication. When it is determined that the component 20 is surely the subject to which the publication key certificate is issued, by decrypting the random number, it is possible to recognize that the subject is the authentic component, instead of referring to information such as the type of the component 20. The certificate authority for components issues the digital certificate only to the authentic component. When the component 20 is normally mounted to a mounting place, it is recognized that the component 20 as an authentication subject is an appropriate type.

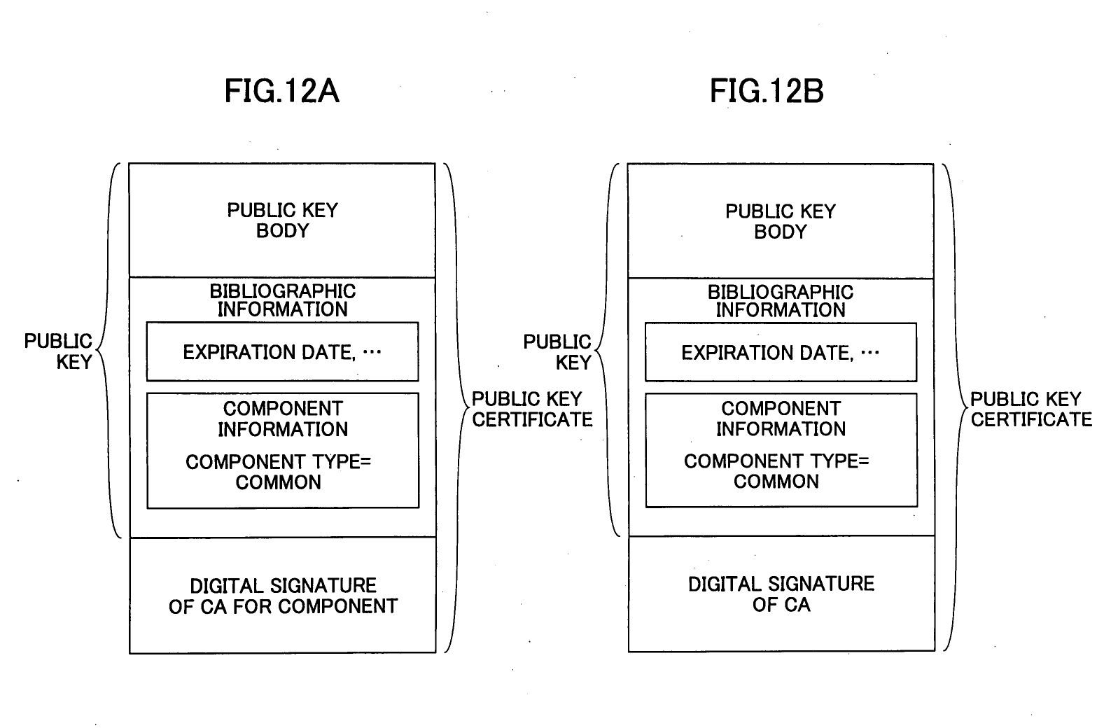

Accordingly, in a case of using the special certificate authority for components, as shown in FIG. 12A, the public key certificate can be created in a format in which the type, the manufacture, and the like of the component 20 are not described. In this case, regardless of the type of the component 20, since the same public key certificate can be used, it is possible to simplify a process for recording the public key certificate in a manufacturing process of the component 20. It should be noted that “COMMON” in FIG. 12A and FIG. 12B is information showing common contents regardless of the type of component 20.

Moreover, in a case in that a minimum authentication is conducted, as shown in FIG. 12B, even if a certificate authority issues in common with the public key certificate at the main device 10, the public key certificate in the format in that the type, the manufacturer, and the like of the component 20 are not described can be used. Furthermore, a public key certificate in that information concerning the component 20 is not described at all may be used.

In this case, if the manufacturer of the main device 10 manages the certificate authority, it can be determined that the component 20 is a product of the same manufacturer of the main device 10 when the component 20 possesses the public key certificate capable of confirming the validity by the root key certificate being recorded in the main device 10.

### Second Embodiment

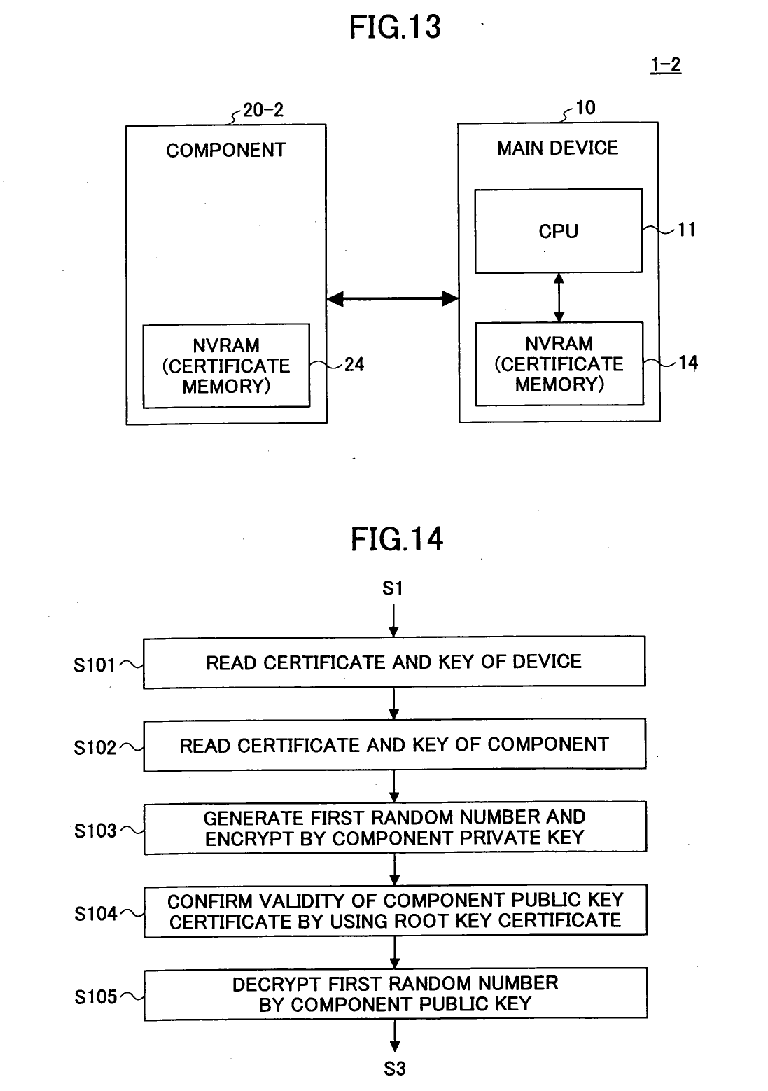

Next, an electronic apparatus according to a second embodiment will be described with reference to FIG. 13 and FIG. 14.

Different from the first embodiment, in an electronic apparatus 1-2 according to the second embodiment, a component 20-2 does not include the CPU 21, the ROM 22, and the RAM 23. That is, in the second embodiment, the configuration shown in FIG. 2 is changed as shown in FIG. 13. FIG. 13 is a diagram briefly showing a configuration according to the second embodiment of the present invention. However, other parts in a hardware configuration are the same as those in the hardware configuration of the first embodiment, and explanations thereof will be omitted. In the second embodiment, the same parts as the first embodiment are indicated by the same numerals.

In a state in that the component 20-2 is mounted in the electronic apparatus 1-2, since the main device 10 and the component 20-2 are included in the same electronic apparatus 1-2 and are connected to each other via a bus, even in a case in that the authentication process is conducted by a PKI (Public Key Infrastructure), a communication between the component 20-2 and the main device 10 can be conducted regardless of the authentication process.

Accordingly, instead of mounting a CPU in the component 20-2, the CPU 11 of the main device 10 can directly obtain the component public key certificate, the root key certificate, and the component private key from the NVRAM 24 of the component 20-2, and can conducts the authentication process by using the component public key certificate, the root key certificate, and the component private key of the component 20-2 and the device public key certificate, the root key certificate, and the device private key of the main device 10. This functional configuration is applied to the second embodiment.

A process conducted by the CPU 11 of the main device 10 when the electronic apparatus 1-2 is activated is the same as the process described with reference to FIG. 6. However, the authentication process shown in step S2 is replaced with an authentication process in accordance with steps S101 through S105 shown in FIG. 14. FIG. 14 is a flowchart for explaining the authentication process according to the second embodiment of the present invention.

That is, the CPU 11 reads out the device public key certificate, the root key certificate, and the device private key of the main device 10 from the NVRAM 14 in step S101, and reads out the component public key certificate, the root key certificate, and the component private key of the component 20-2 from the NVRAM 24 in step S102.

Subsequently, the CPU 11 generates a first random number in step S103, and encrypts the first random number by using the component private key. After that, the CPU 11 checks a validity of the component public key certificate by using the root key certificate in step S104. Similar to step S12 in FIG. 8, a process in step S104 includes a process for confirming by referring the bibliographic information that the component 20-2 is a suitable component to use in the electronic apparatus 1-2.

When it is confirmed that the component 20-2 is a suitable component to use in the electronic apparatus 1-2, the CPU 11 decrypts the first random number by using the component public key included in the component public key certificate in step S105. When this decryption is successful, it shows that the component private key surely corresponds to the component public key certificate and either one of the component private key and the component public key certificate is not replaced.

By the authentication process described above, it is possible for the main device 10 to authenticate the component 20-2. Therefore, it is possible to obtain the same effect as the first embodiment. Since the component 20-2 does not have a CPU and cannot authenticate the main device 10, a one-way authentication is necessarily conducted as described with reference to FIG. 9. In addition, the component 20-2 does not conduct a decryption process, it is not necessary to encrypt a communication between the component 20-2 and the main device 10.

Also, in the second embodiment, the digital certificate as described with reference to FIG. 10 through FIG. 12 can be used for the authentication process.

### Third Embodiment

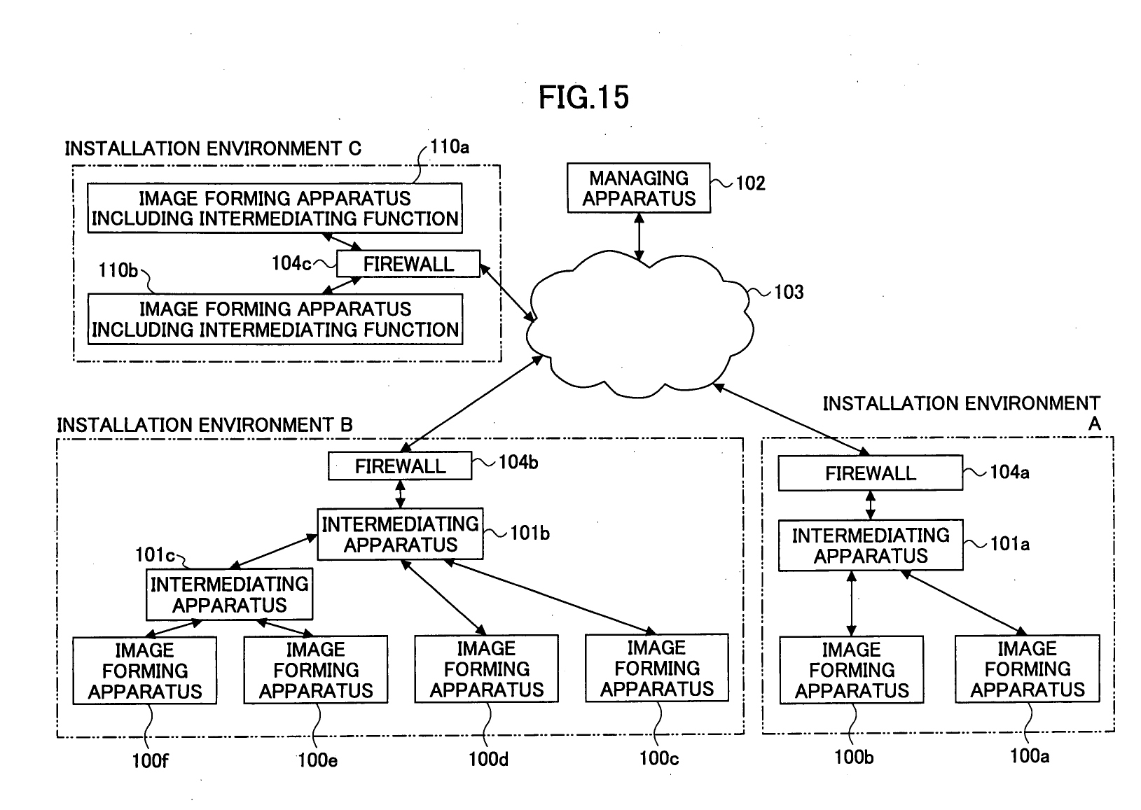

Next, an image forming apparatus management system will be described with reference to FIG. 15 through FIG. 31, according to a third embodiment of the present invention. In the image forming apparatus management system as a remote management system according to the third embodiment, an image forming apparatus as the electronic apparatus according to the present invention is a management subject apparatus.

FIG. 15 is a diagram showing a configuration of the image forming apparatus managing system according to the third embodiment of the present invention.

The image forming apparatus managing system is the remote management system in that a plurality of image forming apparatuses 100a through 100f (collectively called image forming apparatuses 100) are remotely managed by a managing apparatus 102.

As shown in FIG. 15, the image forming apparatus managing system includes the managing apparatus 102, the plurality of image forming apparatuses 100a through 100f, and intermediating apparatuses 101a through 101c (collectively called intermediating apparatuses 101). The intermediating apparatuses 101a through 101c and the image forming apparatus 100a through 100f are provided at installation environments A and B, and can communicate to the managing apparatus 102 via an Internet 103. The remote management system is formed in that the managing apparatus 102 communicates with each of the image forming apparatus 100a through 100f so as to remotely and intensively manage the plurality of the image forming apparatus 100a through

In the remote management system, the intermediating apparatus 101a is mutually connected to and communicates with each of the image forming apparatuses 100a and 100b through a LAN (Local Area Network) in the installation environment A. Also, the intermediating apparatus 101b is mutually connected to and communicates with the image forming apparatuses 100c and 100d and the intermediating apparatus 101C is mutually connected to and communicates with the image forming apparatuses 100e and 100f through a LAN in the installation environment B. To secure communications, a firewall 104a is provided to connect the LAN to an Internet 103 in the installation environment A, and a firewall 104b is provided to connect the LAN to the Internet 103 in the installation environment B,

It is not limited to the LAN to connect the intermediating apparatuses 101a through 101c to respective image forming apparatuses 101a through 101f but a serial connection in conformity to an SR-485 standard or a like, a parallel connection in conformity to a SCSI (Small Computer System Interface) standard, and the like can be used. For example, in a case of using the RS-485, each of the intermediating apparatus 101a through 101c can connect to up to five image forming apparatuses in serial.

Moreover, the intermediating apparatuses 100a through 100c and the image forming apparatuses 100a through 100f may form various hierarchical structures in response to a use environment.

For example, the installation environment A shown in FIG. 15 forms a simple hierarchical structure in that the intermediating apparatus 101a can establish a direct connection with the managing apparatus 102 in accordance with HTTP (HyperText Transfer Protocol) and the image forming apparatuses 100a and 100b are connected under the intermediate apparatus 101a. On the other hand, in the installation environment B in FIG. 15, since four image forming apparatuses 100c through 100f are provided, if only one of the intermediating apparatuses 101b and 101c is provided, a transaction load becomes intensive. Accordingly, a hierarchical structure is formed, so that not only the image forming apparatuses 100c and 100d but also the intermediating apparatus 101b are provided and connected to the intermediating apparatus 101b under the intermediating apparatus 101b capable of establishing the direct connection to the managing apparatus 102 by the HTTP, and the image forming apparatuses 100e and 100f are further provided under the intermediating apparatus 101c and connected to the intermediating apparatus 101c. In this case, information sent from the managing apparatus 102 to remotely manage the image forming apparatuses 100e and 100f reaches to the image forming apparatuses 100e and 100f through the intermediating apparatus 101b and the intermediating apparatus 101c at a lower layer than the intermediating apparatus 101b.

Alternatively, such as an installation environment C, image forming apparatuses 110a and 110b, which are the image forming apparatuses 100 including an intermediating function of the intermediating apparatus 101, may be connected to the managing apparatus 102 through the Internet 103, without passing through the intermediating apparatus 101.

In addition, an image forming apparatus similar to the image forming apparatus 100 can be connected to the image forming apparatus 110 including the intermediating function at a lower layer than the image forming apparatus 110.

In the remote management system described in FIG. 15, the intermediating apparatuses 101 implements an application program for a control management of the image forming apparatuses 100 connecting to the intermediating apparatuses 101. The managing apparatus 102 implements an application program for a control management of each of the intermediating apparatuses 101a through 101b, and further implements an application program for a control management of the image forming apparatuses 100a through 100f through the intermediating apparatuses 101 through 101b and other intermediating apparatuses 101. Each of nodes including the image forming apparatuses 100 in the remote management system can send an operation request for requesting a process with respect to a method of the application program, and can obtain an operation response being a result of the process requested by the operation request, by a RPC (Remote Procedure Call).

That is, the managing apparatus 102 can generate the operation request to send to the image forming apparatuses 100 and the intermediating apparatuses 101, send the operation request to the image forming apparatuses 100 and the intermediating apparatuses 101, and obtain the operation response for the operation request. On the other hand, each of the image forming apparatuses 100 can generate the operation request to send to the managing apparatus 102, send the operation request to the managing apparatus 102, obtain the operation response for the operation request. Also, each of the intermediating apparatuses 101 can generate the operation request to send to the managing apparatus 102, sends the operation request to the managing apparatus 102, and obtain the operation response for the operation request. It should be noted that request contents by the operation request includes a notice without a meaningful execution result.

Moreover, in order to realize the RPC, a well known communication protocol, a well known technology, and a well known specification can be used such as SOAP (Simple Object Access Protocol), HTTP (HyperText Transfer Protocol), FTP (File Transfer Protocol), COM (Component Object Model), CORBA (Common Object Request Broker Architecture), and a like.

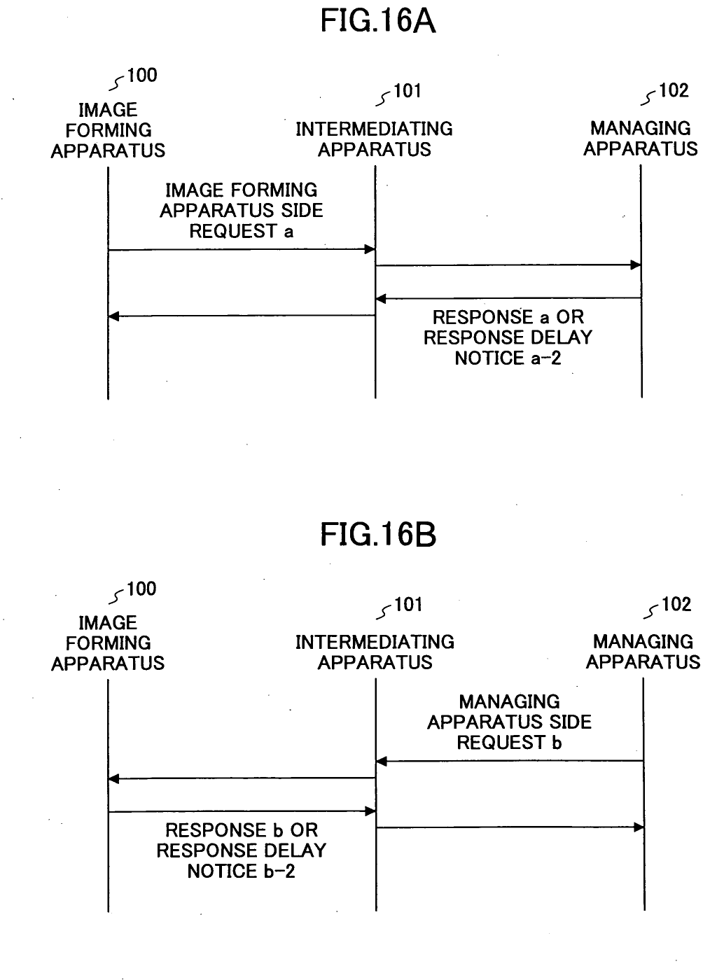

FIG. 16A and FIG. 16B are schematic diagrams showing a data transmission model for sending the operation request and receiving the operation response according to the third embodiment of the present invention.

In FIG. 16A, a case in that the operation request to the managing apparatus 102 occurs at the image forming apparatus 100 is shown. In this case, the image forming apparatus 100 generates an image forming apparatus side request a, and when the managing apparatus 102 receives the image forming apparatus side request a through the intermediating apparatus 101, and the managing apparatus 102 returns a response a with respect to the image forming apparatus side request a. In FIG. 16A, a plurality of the intermediating apparatuses 101 can be implemented (case of the installation environment B shown in FIG. 15). Instead of the response a, a response delay notice a-2 is returned from the managing apparatus 102 to the image forming apparatus 100 through the intermediating apparatus 101. In this case, when the managing apparatus 102 receives a management subject apparatus side request through the intermediating apparatus 101 and determines that a response with respect to the management subject apparatus side request cannot be returned immediately, the managing apparatus 102 sends the response delay notice a-2, disconnects a connection state, and sends the response with respect to the management subject apparatus side request at a next connection.

In FIG. 16B, a request to the image forming apparatus 100 occurs at the managing apparatus 102. In this case, the managing apparatus 102 generates a managing apparatus side request b, and when the image forming apparatus 100 receives the managing apparatus side request b, the image forming apparatus 100 returns a response b with respect to the managing apparatus side request b. Similar to the case shown in FIG. 16A, when the image forming apparatus 100 cannot return the response immediately to the managing apparatus 102, the image forming apparatus 100 sends a response delay notice 2-b to the managing forming apparatus 100 through the intermediating apparatus 101.

Next, a hardware configuration of the image forming apparatus 100 shown in FIG. 15 will be described in detail.

The image forming apparatus 100 uses a process cartridge being an embodiment of a recording medium such as the component 20 recording the digital certificate. The process cartridge is a unit including an image forming part, a toner supplying member for supplying a toner to the image forming part, which will be described later.

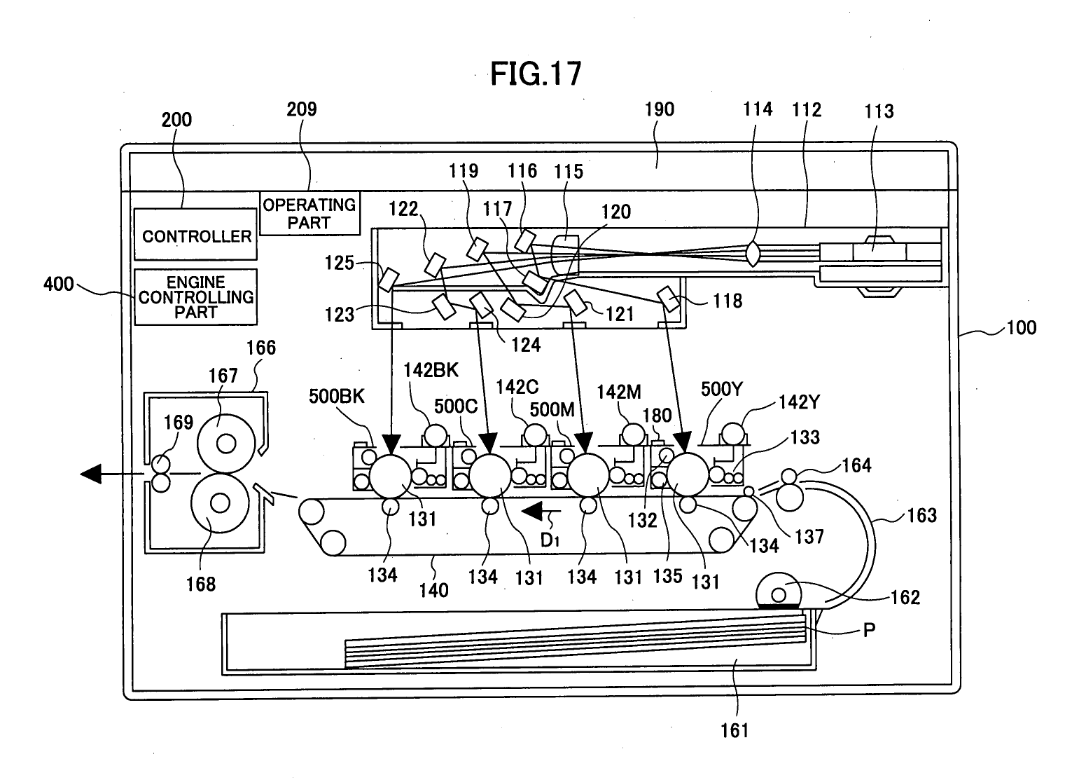

FIG. 17 is a cross sectional view showing a typical entire configuration of the image forming apparatus, according to the third embodiment of the present invention.

The image forming apparatus 100 shown in FIG. 17 is a multi-functional digital apparatus including various image forming functions as a copier, a facsimile, a scanner, and a like and a communication function for communicating to an external apparatus, and implements application programs for providing various services concerning to these functions.

The image forming apparatus 100 includes an optical part (optical unit) 112 for emitting a laser beam based on image information, process cartridges 500Y, 500M, 500C, 500BK being replaceable units detachably mounted to a mounting location corresponding to colors (yellow, magenta, cyan, and black) (hereinafter, collectively called process cartridges 500), a sheet carrying part being formed by a paper accumulating part (paper cassette unit) 161 for accumulating transfer subject media P such as transfer papers, a paper feeding roller 162, a carrier guide 163, a resist roller 164, an adsorption roller 137, a transfer belt 140, and a like, a heating roller 167, a pressing roller 168, and an eject roller 169, and further including a fixing unit 166 for fixing a not-fixed image on the transfer subject media P, a scanner 190 for optically reading a manuscript being placed, an operating part 209 being provided so as to partially expose from an outer covering of a main device, a controller 200 as a controlling part for controlling overall operations of the image forming apparatus 100, and an engine controlling part 400 for controlling an operation of an engine part.

In this case, the present invention is applied to the image forming apparatus 100 for a color image formation is shown but the present invention can apply to an image forming apparatus for a black and white image formation. In a case of the black and white image formation, the image forming apparatus 100 includes a single process cartridge.

In the image forming apparatus 100, each of the process cartridges 500 for colors includes a photosensitive drum 131 as an image holding member, a live part 132 for electrifying on the photosensitive drum 131, a developing part 133 for developing an electrostatic latent image being formed on the photosensitive drum 131, a cleaning part 135 for collecting a not-transferred toner on the photosensitive drum 131, toner supplying parts 142Y, 142M, 142C, and 142BK (collectively called toner supplying parts 142) for supplying a toner to the developing part 133, a control chip 180 used to identifying the process cartridges 500, which are integrally maintained. Moreover, a transfer roller 134 for transcribing a toner image formed on the photosensitive drum 131 to the transfer subject media P is arranged at a location corresponding to the photosensitive drum 131.

Then, an image formation corresponding to each color is conducted onto the photosensitive drum 131 of each of the process cartridges 500. In this case, toners of colors are supplied from the toner supplying parts 142Y, 142M, 142C, and 142BK, to the developing parts 133 of the process cartridges 500, respectively.

In the following, an operation for a regular color formation in the image forming apparatus 100 will be described.

In a case of conducting the image formation, four photosensitive drums 131 rotate in a clockwise direction in FIG. 17. First, a surface of each photosensitive drum 131 is uniformly electrified at a facing side to the live part 132 (electrifying process). After that, the surface of each photosensitive drum 131, which is electrified, approaches an emitting position of the laser beam.

On the other hand, image data concerning an image to form are supplied to the optical unit 112. Then, in the optical unit 112, each of laser beams corresponding to image signals is emitted from a LD (laser diode) light source with respect to a respective color. After the laser beams are incident to and are reflected from a polygon mirror 113, the laser beams pass through lenses 114 and 115. After the laser beams pass through the lenses 114 and 115, the laser beams filter out respective light paths corresponding to color components: yellow, magenta, cyan, and black.

After a laser beam for a yellow component is reflected at mirrors 116 through 118, the laser beam for the yellow component is illuminated on the surface of the photosensitive drum 131 of the process cartridge 500Y, which is a first process cartridge from a right side in FIG. 17. In this case, the laser beam for the yellow component is scanned in a spin shaft direction (main scanning direction) of the photosensitive drum 131 by the polygon mirror 113 being spun at a high speed. The electrostatic latent image of the yellow component is formed on the photosensitive drum 131 being electrified by the live part 132.

Similarly, after a laser beam for a magenta component is reflected at mirrors 119 through 121, the laser beam for the magenta component is illuminated on the surface of the photosensitive drum 131 of the process cartridge 500M, which is a second process cartridge from the right side in FIG. 17, and an electrostatic latent image of the magenta component is formed on the photosensitive drum 131. After a laser beam for a cyan component is reflected at mirrors 122 through 124, the laser beam for the cyan component is illuminated on the surface of the photosensitive drum 131 of the process cartridge 500C, which is a third process cartridge from the right side in FIG. 17, and an electrostatic latent image of the cyan component is formed on the photosensitive drum 131. After a laser beam for a black component is reflected at a mirror 125, the laser beam for the black component is illuminated on the surface of the photosensitive drum 131 of the process cartridge 500BK (exposing process).

After that, the surface of each of the photosensitive drums 131 forming the electrostatic latent images for four colors further rotates and achieves a facing position to the developing part 133. A toner for each color is supplied onto the respective photosensitive drum 131 from the developing part 133, so that a latent image formed on the photosensitive drum 131 is developed (developing process).

After the developing process, the surface of each of the photosensitive drum 131 achieves a facing position to the transfer belt 140. At each facing position, the transfer roller 134 is arranged so as to contact an inner surface of the transfer belt 140. At a position of the transfer roller 134, each of toner images for four color formed on the photosensitive drum 131 is sequentially transferred onto the transfer subject medium P being conveyed by the transfer belt 140 (transferring process).

At a transfer belt unit (transferring part), the transfer belt 140 is extended and supported by a driving roller and three driven rollers. The transfer belt 140 scans by the driving roller along an arrow direction D1 in FIG. 17. In this transfer belt unit, members such as the transfer roller 134, the transfer belt 140, and the like are integrated so as to form a device unit being replaceable with respect to the main device.

Then, each surface of the photosensitive drums 131 achieves a facing position to the cleaning part 135. Then, at the cleaning part 135, the not-transferred toner is collected (cleaning process).

After that, each surface of the photosensitive drums 131 passes by an electricity removing part which is not shown in FIG. 17, and then a series of an image developing process is terminated.

On the other hand, from the paper accumulating part 161 (paper cassette unit), after the transfer subject medium P being conveyed by the paper feeding roller 162 passes through the carrier guide 163, the transfer subject medium P is led to a position of the resist roller 164. The transfer subject medium P let to the position of the resist roller 164 is conveyed toward a contact portion with the transfer belt 140 and the adsorption roller 137 while a conveying timing is controlled.

After that, the transfer subject medium P is conveyed by the transfer belt 140 scanning along the arrow direction D1 in FIG. 17, and sequentially passes the facing position to each of four photosensitive drums 131. Accordingly, the toner image for each color is transferred over the transfer subject medium P, and then a color image is formed.

After that, the transfer subject medium P on which the color image is formed pull out of the transfer belt 14 of the transfer belt unit, and is let to the fixing part 166. In the fixing part 166, the color image is fixed on the transfer subject medium P at a nip part between the heating roller 167 and the pressing roller 168.

After the color image is fixed, the transfer subject medium P is ejected out from the main device by the eject roller 169, and then a series of the image forming operation ends.

Next, the process cartridge 500 detachably mounted to the image forming apparatus 100 will be described in detail.

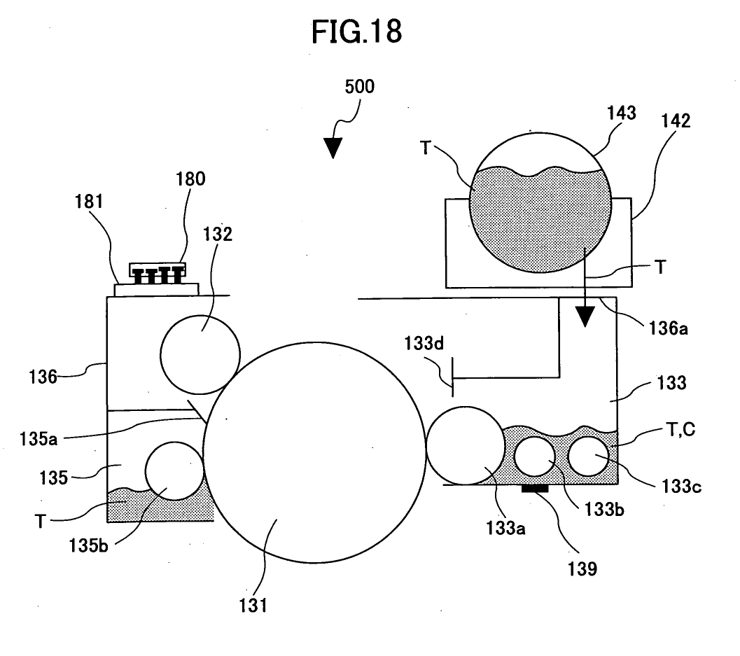

FIG. 18 is a cross sectional view showing the process cartridge being in a brand-new state according to the third embodiment of the present invention. The brand-new is a state in that a not-recycle product or a recycle product has not been used at all for the main device after manufactured or processed to recycle.

As shown in FIG. 18, the process cartridge 500 integrally accommodates the photosensitive drum 131 as the image holding member, the live part 132, the developing part 133, the cleaning part 135, and the like within a case 136a, and further integrally accommodates the toner supplying part 142. Therefore, the process cartridge 500 is called toner cartridge.

In addition, the developing part 133 includes a development roller 133a, agitating rollers 133b and 133c, a doctor blade 133d, a T-sensor 139 (toner concentration sensor), and a like, and accommodates a developer including a carrier C and a toner T inside the developing part 133. The toner T within the toner bottle 143 provided to the toner supplying part 142 is appropriately supplied to the developing part 133 based on a consumption amount of the toner T within the developing part 133. Moreover, the cleaning part 135 includes a cleaning blade 135a, a cleaning roller 135b, and a like.

Moreover, a control chip 180 is fixed on the case 135 of the process cartridge 500. The control chip 180 is a microcomputer including a CPU, an NVRAM (Non-Volatile RAM), and a like, and is also an IC (Integrated Circuit) being packaged and having external terminals. Details will be described later. Moreover, the external terminals of the control chip 180 are connected to connection terminals of a socket 181 fixed to the case 136. It should be noted that the control chip 180 is not limited to a specific feature. An IC chip having a few mm square size can be used as the control chip 180, or a IC package mounting an IC chip on a PCB (Printed Circuit Board) having external terminals can be used as the control chip 180.

The process cartridge 500 has shorter product life than the main device of the image forming apparatus 100. The process cartridge 500 is a consumable component which is replaced in a case in that the photosensitive drum 131, the cleaning part 135, and the like are worn out or in a case in that a toner in the toner bottle 143 is consumed. Then, the toner cartridge 500 is replaced by a user per process cartridge unit. In this case, the user opens a door (not shown in FIG. 17 and FIG. 18) of the main device, mounts a new process cartridge 500 within the main device by inserting the new process cartridge 500 along a rail (not shown in FIG. 17 and FIG. 18).

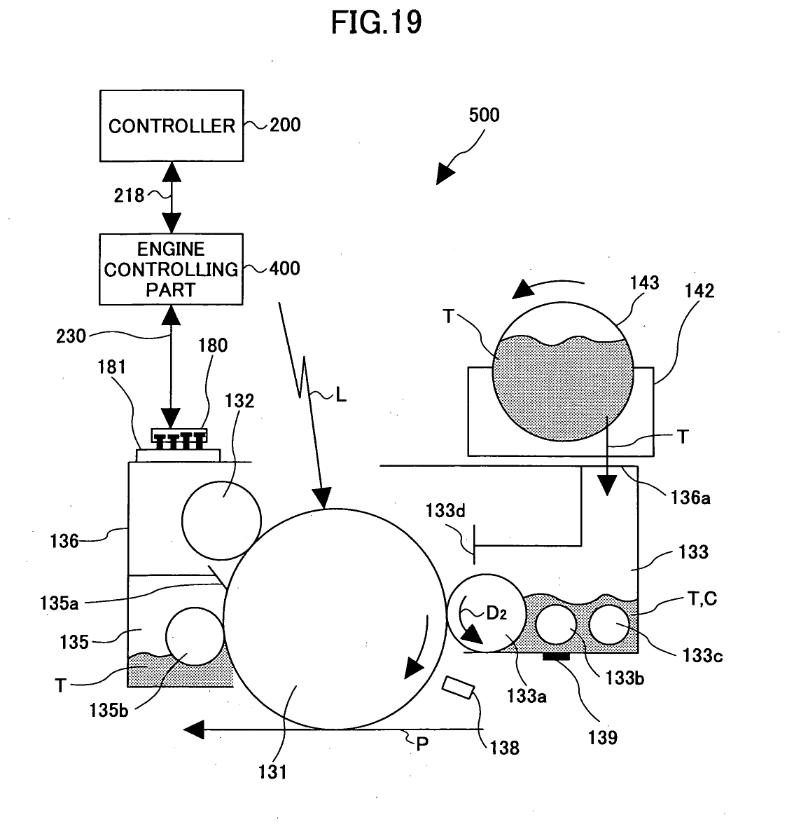

FIG. 19 is a cross sectional view showing a typical peripheral state in a case in that the process cartridge is arranged at an arrangement position in the image forming apparatus according to the third embodiment of the present invention.

In this state, the socket 181 of the process cartridge 500 is connected to a CPU 401 of an engine controlling part 400 through a serial bus 230, and the control chip 180 is placed in a state capable of communicating with the engine controlling part 400 and a PCI bus 218 through a controller 200.

Moreover, the process cartridge 500 conducts the image forming operation by using the toner T being supplied from the toner bottle 143 in this state.

That is, the development roller 133a rotates in an arrow direction D2 in FIG. 19, and the toner T within the developing part 143 is mixed with the carrier C and the toner T being supplied from the toner supplying part 142 by the agitating rollers 133b and 133c which are rotating in a counterclockwise direction. The toner T being frictionally charged is supplied onto the development roller 133a with the carrier C by another agitating roller 133b.

Consumption of the toner T within the developing part 133 is detected by a toner concentration sensor (P sensor) 138 as an optical sensor facing to the photosensitive drum 131 and a toner concentration sensor (T sensor) 139 as a magnetic permeability sensor provided in the developing part 133, and a detection result is informed to the CPU on the control chip 180.

Moreover, after the toner T carried by the development roller 133a passes by a position of the doctor blade 133d, the toner T achieves a facing position to the photosensitive drum 131. At the facing position, the toner T adheres the electrostatic latent image formed on the surface of the photosensitive drum 131. In detail, the toner T adheres the surface of the photosensitive drum 131 by an electric field formed by an electric potential difference between an electric potential of an area, in which the laser beam L is illuminated, and a developing bias applied to the development roller 133a.

Almost all of the toner T being adhered to the photosensitive drum 131 is transferred on the transfer subject medium P. The toner T remaining on the photosensitive drum 131 is collected within the cleaning part 135 by the cleaning blade 135a and the cleaning roller 135b.

In this case, the process cartridge 500 and the toner supplying part 142 are formed as a single consumable component. Alternatively, the toner supplying part 142 can be individually formed as a replaceable unit. In this case, when the toner T in the toner bottle 143 becomes empty, the toner supplying part 142 or the toner bottle 143 is replaced with a new unit per a unit of the toner supplying part 142 or the toner bottle 143.

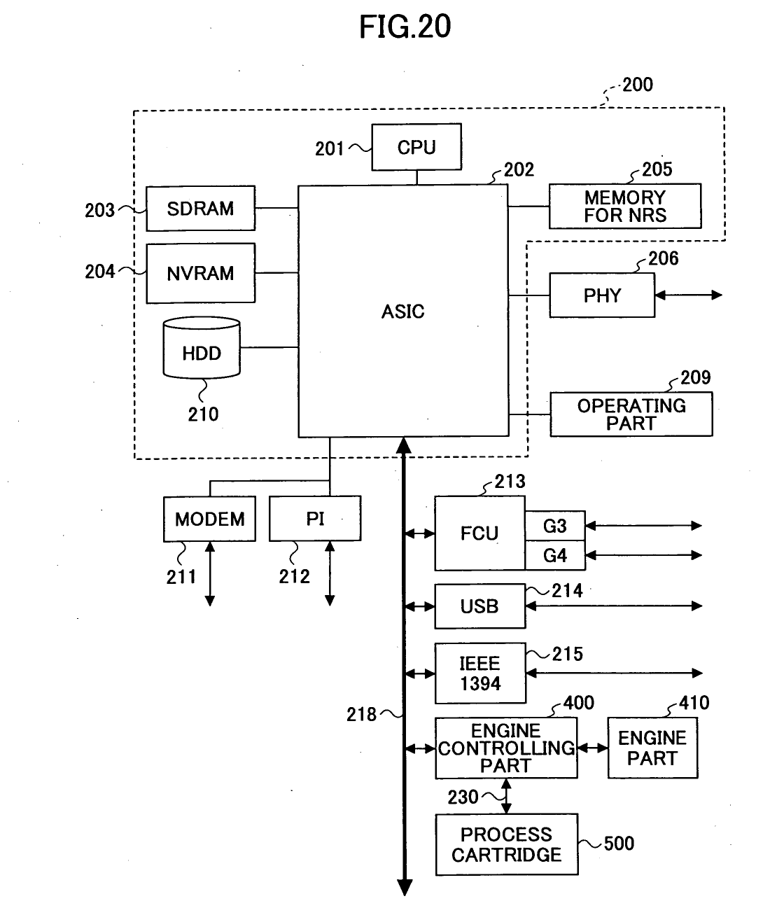

Next, regarding a configuration of the image forming apparatus 100, a hardware configuration related to a control or a communication will be mainly described. FIG. 20 is a block diagram mainly showing the hardware configuration related to the control and the communication of the image forming apparatus 100 according to the third embodiment of the present invention.

As shown in FIG. 20, the image forming apparatus 100 includes a CPU 201, an ASIC (Application Specific Integrated Circuit) 202, an SDRAM 203, an NVRAM (Non-Volatile RAM), an NRS memory 205, a PHY (Physical media interface) 206, an operating part 209, an HDD (Hard Disk Drive) 210, a modem 211, a PI (Personal Interface) 212, an FCU (Fax Control Unit) 213, a USB (Universal Serial Bus) 214, an IEEE 1394 215, an engine controlling part 400, an engine part 410, and at least one process cartridge 500.

The CPU 201 is an operating part that conducts a data process (control of each function) through the ASIC 202.

The ASIC 202 is a multi-functional device board including a CPU interface, an SDRAM interface, a local bus interface, a PCI interface, a MAC (Media Access Controller) an HDD interface, and a like, promotes to share devices that are control subjects of the CPU 201, to make developments of application software and a common system service more efficient in a viewpoint of an architecture.

The SDRAM 203 is a main memory used as a program memory recording various programs including an OS (Operating System), a work memory used when the CPU 201 conducts a data process. Instead of the SDRAM 203, a DRAM (Dynamic Random Access Memory) or an SRAM (Static Random Access Memory) can be used.

The NVRAM 204 is a memory (recording part) being non-volatile, and maintains recorded contents even if a power is off. The NVRAM 204 can be used as a program memory recording a boot loader (boot program) for activating the image forming apparatus 100 and an OS image being a file of the OS. Moreover, the NVRAM 204 can be used as a certificate memory recording a mutual authentication by an SSL (Secure Socket Layer) for a communication with an external communication partner, and the digital certificate used for the mutual authentication using the PKI, which is conducted with a consumable component such as the process cartridge 500. Furthermore, the NVRAM 204 can be used as a fixed parameter memory recording various fixed parameters such as an initial value of the printer function and/or an initial value of the scanner function, which are hardly changed at all, a device number memory recording a device number being identification information of the image forming apparatus 100, a memory recording initial values for operations using the operating part 209, a memory recording each initial value of applications (APL), or a memory recording counter information such as data concerning various accounting counters, or a like.

The NVRAM 204 can be formed by a plurality of memories. Alternatively, the NVRAM 204 can be arranged to each of parts of the image forming apparatus 100. Also, as a memory for the NVRAM 204, for example, a non-volatile RAM integrating backup circuits using a RAM and a battery, an EEPROM (Electronically Erasable and Programmable Read Only Memory), and a non-volatile memory such as a flash memory can be used.

The NRS memory 205 is a non-volatile memory recording an NRS application, which will be described later, and an NRS function can be additionally recorded in the NRS memory 205 as an option.

The PHY 206 is an Interface for communicating with an external device through a LAN, and functions as a second communicating part in conjunction with the CPU 201.

The operating part 209 is an operation displaying part (including an operating part and a displaying part).

The HDD 210 is a recording part (recording medium) for recording and maintaining data, regardless of power ON and power OFF. Also, the HDD 210 can record the programs in the NVRAM 204 and other data.

The modem 211 is a modulating/demodulating part. When data is sent to the external device through a public line, the modem 211 modulates the data so as to send to the public line. Also, when modulated data is received from the external device through the public line, the modem 211 demodulates the modulated data.

The PI 212 includes an interface in conformity to the RS-485 standards, and connects to the public line through a line adaptor that is not shown in FIG. 20. The modem 211 and the PI 212 may function as the second communicating part.

The FCU 213 controls a communication with the external device such as a managing apparatus and an image forming apparatus such as a digital copier or a digital multi-functional apparatus including a FAX device or a modem function (FAX communicating function), through the public line.

The USB 214 and the IEEE 1394 215 is an interface for the USB standard and the IEEE 1394 standard, respectively, for communicating with peripheral devices.

The engine controlling part 400 is a controlling part for controlling an operation of the engine part 410 in accordance with an instruction sent from the controller 200, and is an interface for connecting the engine part 410 to the PCI bus 218. In addition, the engine controlling part 400 includes a function for intermediating a communication between the CPU of the process cartridge 500 and the CPU 201 of the controller 200.

The engine part 410 corresponds to a post-processing unit for conducting a post-process such as a staple process, a punch process, a sort process, or a like with respect to a paper sheet in which the image is formed by an engine or a plotter engine for reading or forming an image shown in FIG. 17.

The process cartridge 500 includes the above-described configuration, and is connected to the engine controlling part 400 by the serial bus 230.

When the power is turned on (power ON), the CPU 201 activates the boot loader recorded in the NVRAM 204 via the ASIC 202, reads out the OS image recorded in the NVRAM 204 in accordance with the boot loader, and loads the OS image to the SDRAM 203 to develop to be usable as the OS. When the OS is developed, the OS is activated by the CPU 201. After that, if necessary, the CPU 201 reads out the program such as an application recorded in the NVRAM 204 or the NRS application recorded in the NRS memory 205, loads the program to the SDRAM 203 to develop, and activates the program, so that various functions can be realized.

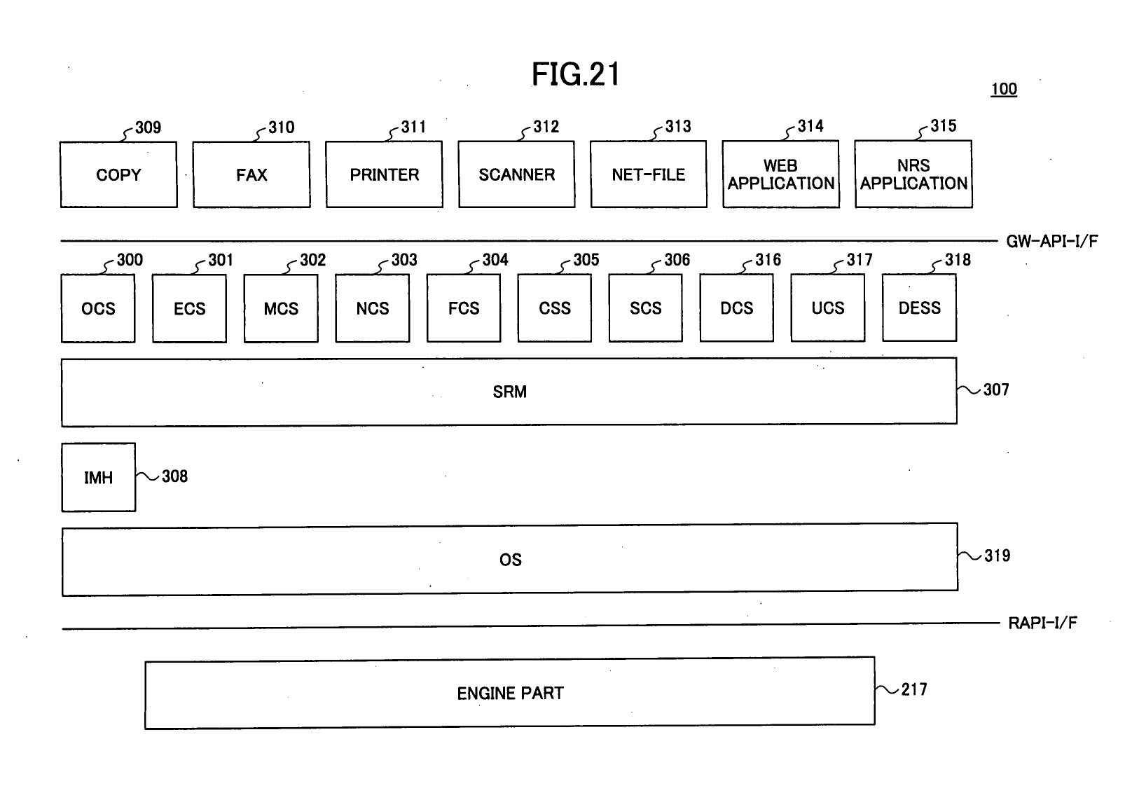

Next, a software configuration in the image forming apparatus 100 will be described with reference to FIG. 21.

FIG. 21 is a block diagram showing one example of the software configuration of the image forming apparatus according to the third embodiment of the present invention. In the software configuration shown in FIG. 21, the image forming apparatus 100 includes an application module layer at the most significant layer, and a service module layer under the most significant layer. Programs forming the software are recorded in the NVRAM 204 and the NRS memory 205, and if necessary, the programs are read out by the CPU 201 to execute.

The software in the application module layer is formed by programs that cause the CPU 201 to function as a plurality of application controlling parts (process executing part) for realizing a predetermined function by operating hardware resources. The software in the service module layer is formed by programs that cause the CPU 201 to function as a plurality of service controlling parts (process executing parts) for conducting an execution control to accept an operation request with respect to the hardware resources, to intermediate the operation request, and to execute an operation based on the operation request received from the plurality of application controlling parts. The service controlling parts are arranged between the hardware resources and each of the plurality of the application controlling parts.

An OS 319 is an operating system such as UNIX™, executes each program of the service module layer and the application module layer as a process in parallel, and control an engine part 217.

The service module layer implements an operation control service (OCS) 300, an engine control service (ECS) 301, a memory control service (MCS) 302, a network control service (NCS) 303, a FAX control service (FCS) 304, a customer support system (CSS) 305, a system control service (SCS) 306, a system resource manager (SRM) 307, an image memory hander (IMH) 308, a delivery control service (DCS) 316, a user control service (UCS) 317, and a data encryption security service (DESS) 318. The application module layer implements a copy application 309, a FAX application 310, a printer application 311, a scanner application 312, a net-file application 313, a Web application 314, and NRS (New Remote Service) application 315.

Details will be described.

The OCS 300 is a module for controlling the operating part 209.

The ECS 301 is a module for controlling engines such as the hardware resources, and the like.

The MCS 302 is a module for conducting a memory control, and for example, the MCS 302 obtains and release the image memory and uses the HDD 210, and the like.

The NCS 303 is a module for conducting an intermediating process between a network and each of the programs in the application module layer.

The FCS 304 is a module for transmission data by fax, reading data via fax, printing out data received by fax, and a like.

The CSS 305 is a module for converting data when the data is transmitted through the public line, and is also a module integrating functions concerning a remote management through the public line.

The SCS 306 is a module for conducting an activation management and a termination management of programs in the application module layer in response to contents of a command.

The SRM 307 is a module for controlling a system and managing each resource.

The IMH 308 is a module for managing a memory to temporarily store image data.

The DCS 316 is a module is a module for sending and receiving an image file or a like, which is recorded in or is to record to the HDD 210, or the SDRAM 203, by using an SMTP (Simple Mail Transfer Protocol) or a FTP (File Transfer Protocol).

The UCS 317 is a module for managing user information such as destination information, destination name information, or a like, which is registered by a user.

The DESS 318 is a module for authenticating each component or the external device and encrypting a communication by using PKI and SSL.

The copy application 309 is an application program to realize a copy service.

The FAX application 310 is an application program to realize a FAX service.

The printer application 311 is an application program to realize a printer service.

The scanner application 312 is an application program to realize a scanner service.

The net-file application 313 is an application program to realize a net-file service.

The Web application 314 is an application program to realize a Web service.

The NRS application 315 is an application program to realize a data conversion in order to send and receive data through the network, and to realize a function (including a function concerning a communication with the managing apparatus 102) concerning the remote management through the network.

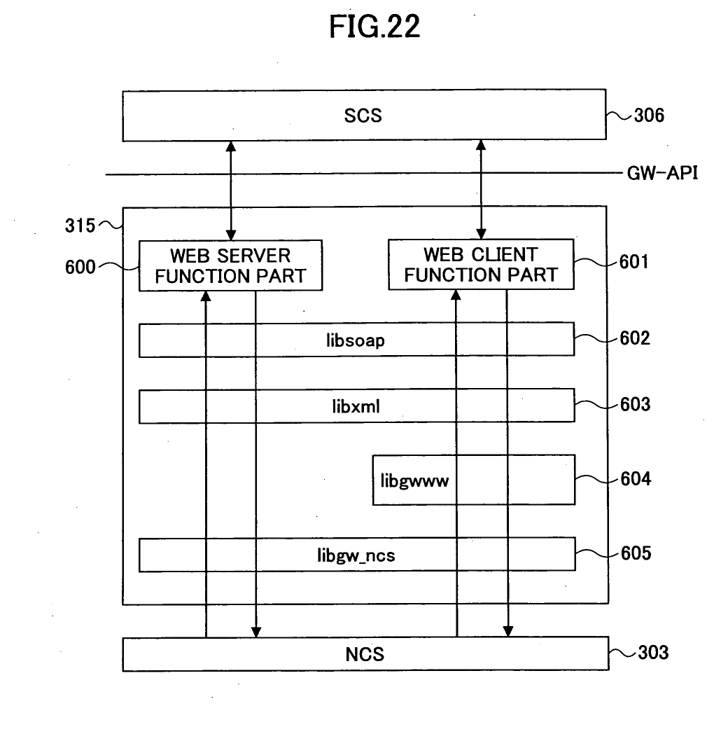

Next, an internal configuration of the NRS application 315 included in the software configuration of the image forming apparatus 100 will be further described with reference to FIG. 22.

FIG. 22 is a block diagram showing the internal configuration of the NRS application according to the third embodiment of the present invention. As shown in FIG. 22, the NRS application 315 conducts a process between the SCS 306 and the NCS 303. A Web server function part 600 conducts a response process concerning a request received from outside. For example, the request may be an SOAP (Simple Object Access Protocol) request in accordance with an SOAP. The SOAP request is described in an XML (Extensible Markup Language) format in that the XML is a structured language. A Web client function part 601 conducts a process for issuing a request to the outside. A libsoap 602 is a library to process the SOAP, and a libxml 603 is a library to process data desribed in the XML format. Also, a libgwww 604 is a library to process the HTTP, and a libgw_ncs 605 is a library to process between the libgw_ncs 605 and the NCS 303.

In the image forming apparatus 100 as described above, when the image forming apparatus 100 is activated due to the power ON or the reset, in an initializing process, an authentication process using PKI is conducted between the controller 200 and the process cartridge 500 as a replaceable consumable component, and an warning is issued when authentication fails. Operations concerning the authentication process and the warning are conducted in the same manner described above in the first embodiment and the second embodiment. However, in the image forming apparatus 100, a communication between the controller 200 corresponding to the main device 10 at the main device side and the process cartridge 500 corresponding to the component 20 is conducted through the engine controlling part 400.

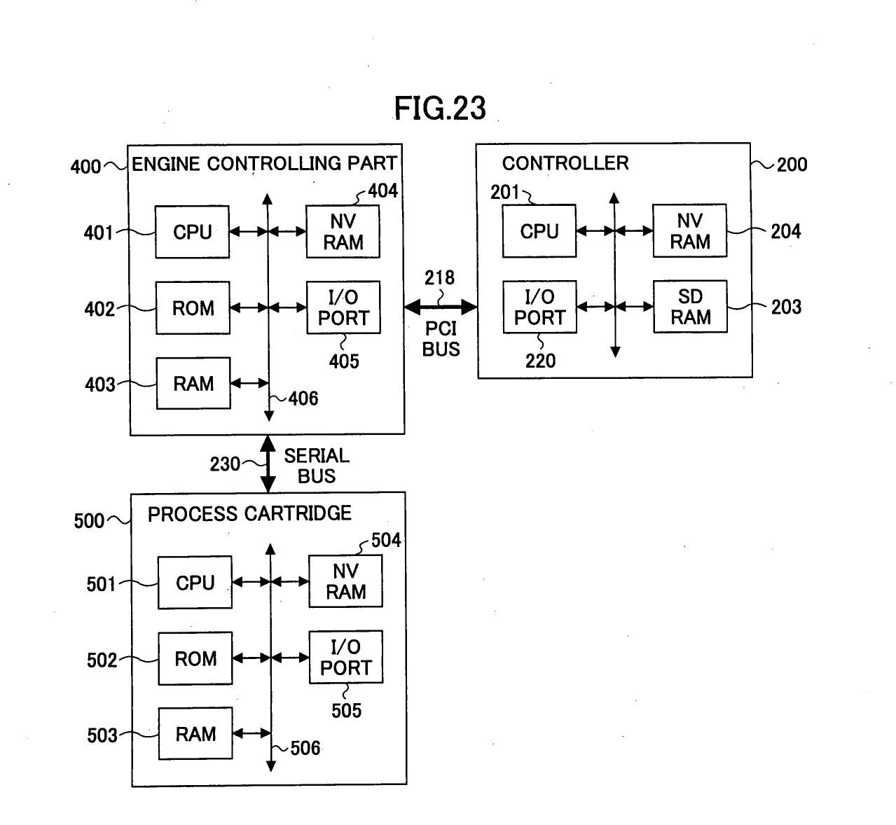

FIG. 23 is a block diagram showing a hardware configuration of each part related to the authentication process and the warning according to the third embodiment of the present invention. For the sake of convenience, a configuration and processes concerning a single process cartridge 500 will be described in the following. Other process cartridges 500 also have the same configuration and the same processes are conducted in parallel or in serial between the controller 200 and the engine controlling part 400.

The controller 200, the engine controlling part 400, and the process cartridge 500 are involved in the mutual authentication.

The hardware configuration of the controller 200 is as described above, and the hardware configuration of the controller 200 is partially shown. An I/O port 220 shows a connection port to connect with the PCI bus 218 provided in the AXIC 202.

Moreover, the engine controlling part 400 includes a CPU 401, an ROM 402, an RAM 403, an NVRAM 404, and an I/O port 405, which are connected to each other by an internal bus 406. Then, the CPU 401 conducts processes concerning a control of the engine part 410, and processes concerning data communications with the controller 200 and the process cartridge 500.

The process cartridge 500 includes a CPU 501, a ROM 502, a RAM 503, an NVRAM 504, and an I/O port 505, which are connected to each other via an internal bus 506. The digital certificate and the key used for the authentication process are recorded in the NVRAM 504. The CPU 501 conducts processes concerning a control and a data management of the process cartridge 500, a data communication with the engine controlling part 400, and the authentication, by executing programs recorded in the ROM 502 and the NVRAM 504. That is, the CPU 501 functions as a communicating part and an operating part. Theses parts are provided to the control chip 180 or the socket 181.

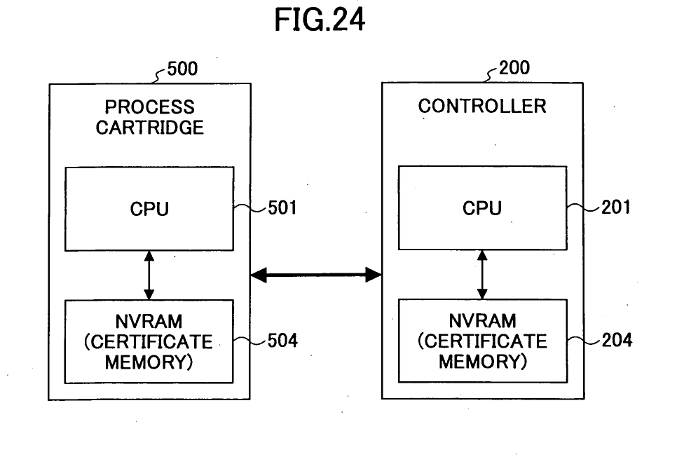

In the hardware configuration shown in FIG. 23, in a case of communicating with the controller 200 and the process cartridge 500, the engine controlling part 400 simply conducts a function for intermediating a communication between the controller 200 and the process cartridge 500. Accordingly, in a case in that the controller 200 and the process cartridge 500 conduct the mutual authentication, a brief hardware configuration concerning the mutual authentication is shown in FIG. 24. FIG. 24 is a block diagram showing the brief hardware configuration concerning the mutual authentication conducted between the controller 200 and the process cartridge 500, according to the third embodiment of the present invention.

That is, the CPU 201 of the controller 200 reads out the digital certificate and the key at a controller side, which are necessary for the authentication process, from the NVRAM 204 functioning as the certificate memory.

Moreover, the CPU 501 of the process cartridge 500 reads out the digital certificate and the key at a process cartridge side, which are necessary for the authentication process, from the NVRAM 504 functioning as the certificate memory. The CPU 201 and the CPU 501 communicate to each other to conduct the authentication process by using the digital certificate and the key. In this case, both the CPU 201 and the CPU 501, and buses and interfaces correspond to a communicating part.

Other configurations, which are not shown in FIG. 23, and other drawings, are secondarily concerned to the authentication process. The controller 200 and the process cartridge 500 shown in FIG. 24 conduct processes corresponding to the main device 10 and the component 20 shown in FIG. 2, respectively, so as to conduct authentication of the component and a control based on the authentication result similarly to the first embodiment. Moreover, in a case of providing the CPU 501 for the process cartridge 500, the authentication of the component and the control based on the authentication result similarly to the second embodiment.

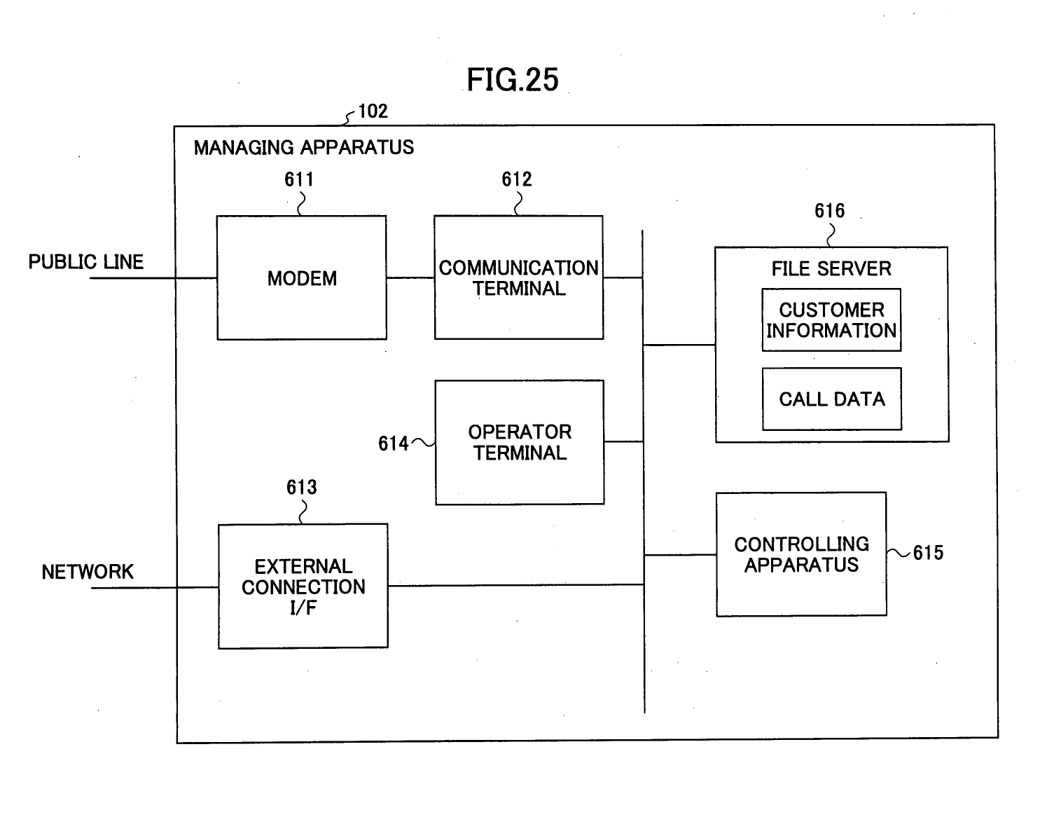

Next, FIG. 25 is a block diagram showing a brief hardware configuration of the managing apparatus according to the third embodiment of the present invention.

The managing apparatus 102 includes a modem 611, a communication terminal 612, an external connection I/F 613, an operator terminal 614, a controlling apparatus 615, a file server 616, and a like.

The modem 611 is used to communicate with the intermediating apparatus 101 (for example, provided at a user side at which a user uses the image forming apparatus 110) or the image forming apparatus 110 at an apparatus user side, through a public line, which is not shown in FIG. 25, and modulates and demodulates data being sent and received. The modem 611 and the communication terminal 612 function as a communicating part.

The external connection I/F 613 is an interface to communicate through the Internet 103 or a dedicated network. Then, a communication with the intermediating apparatus 101 or the image forming apparatus 110 at the apparatus user side is conducted through the external connection I/F 613. For a security management, a proxy server or a like may be provided.

The operator terminal 614 accepts inputs of various data which an operator inputs by operations using an input device such as a keyboard or a like. For example, data to input may be an IP address used to communicate with the intermediating apparatus 101 or the image forming apparatus 110 at each apparatus user side, customer information such as a telephone number (call destination telephone number).

The controlling apparatus 615 includes a microcomputer including a CPU, a ROM, a RAM, and a like which are not shown in FIG. 25, and integrally controls the entire the managing apparatus 102.

The file server 616 includes a storage device such as a hard disk device that is not shown in FIG. 25, and records various data such as IP addresses and telephone numbers of the intermediating apparatus 101 and the image forming apparatus 110 at each apparatus user side, data received from each apparatus user side, identification information of the image forming apparatus 100 as a management subject, input data which are input by the operator terminal 614, as respective databases (DB).

A hardware configuration of the intermediating apparatus 101 will be described. The intermediating apparatus 101 includes a CPU, a ROM, a RAM, a non-volatile memory, a network interface card (NIC), and a like.

Simply, these units forming the hardware configuration of the image forming apparatus 110 including the intermediating apparatus 101 can be additionally provided to the image forming apparatus 100. Alternatively, hardware resources such as the CPU, the ROM, the RAM, and the like mounted in the image forming apparatus 100 can be used, the CPU of the image forming apparatus 100 executes appropriate applications and program modules so as to realize functions of the intermediating apparatus 101.

In the third embodiment, the image forming apparatus 100 functioning as the remote managing system conducts a process corresponding to the remote management in addition to processes concerning the authentication of the component as described above in the first embodiment and the second embodiment and a operation control based on the authentication result. Next, as an example of a special process of the remote management conducted by the image forming apparatus 100 functioning as the remote managing system, a process concerning an automatic ordering function in a case in that a toner quantity is reduced will be described in the following.

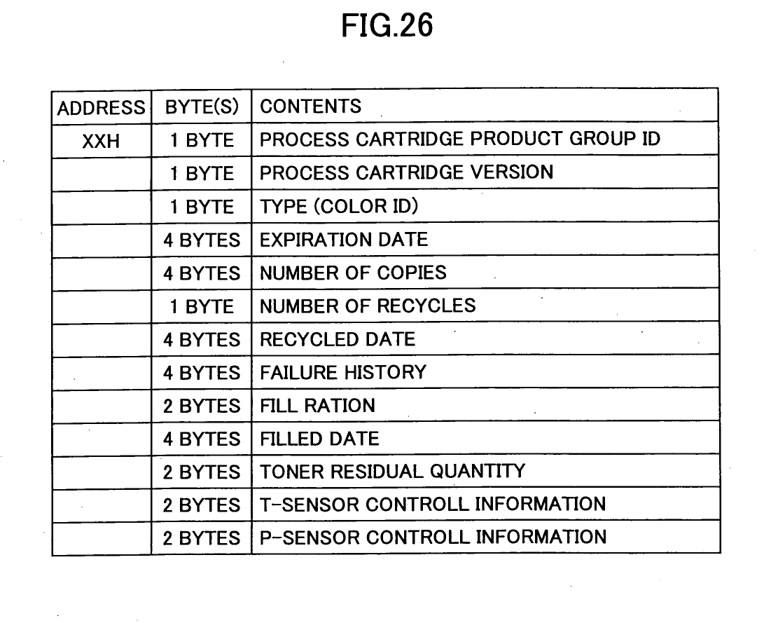

In the image forming apparatus 100, a predetermined record area is acquired in the NVRAM 504 of the process cartridge 500. As shown in FIG. 26, information necessary to rewrite in information concerning the process cartridge 500 is recorded in the predetermined record area. The entire or a part of information necessary to rewrite is used as control information when the controller 200 controls an operation of the image forming apparatus 100.

For example, “NUMBER OF COPIES” shows the number of sheets to which the image formation is conducted after the process cartridge 500 is mounted to the image forming apparatus 100. When “NUMBER OF COPIES” becomes greater than a predetermined number, it is considered that the photosensitive drum 131 may be worn out. “NUMBER OF RECYCLES” shows the number of recycles. When “NUMBER OF RECYCLES” becomes greater than a maximum recycle number shown in a cartridge certificate, by the control of the controller 200, the image formation using the process cartridge 500 cannot be conducted.

Moreover, “TONER RESIDUAL QUANTITY” shows the toner quantity in the toner bottle 143. The operation explained here is an operation for automatically ordering a process cartridge for the replacement with respect to the managing apparatus 102 when “TONER RESIDUAL QUANTITY” becomes lower than a predetermined value.

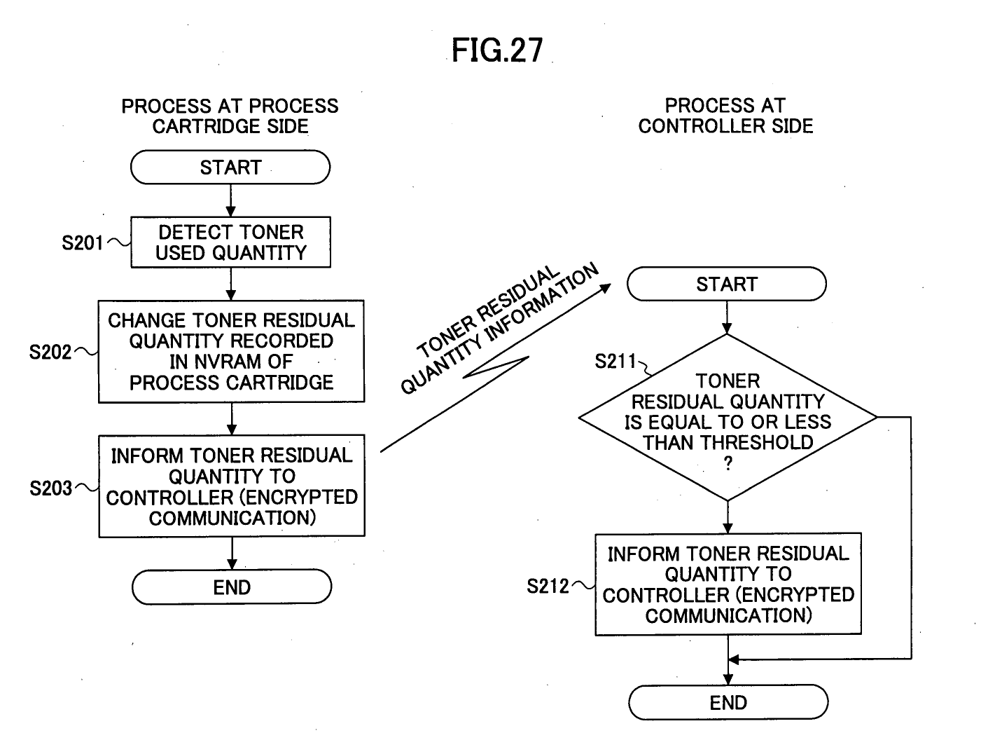

Regarding this operation, processes executed by executing the CPU 501 of the process cartridge 500 and the CPU 201 of the controller 200 will be described with reference to FIG. 27.

The CPU 501 of the process cartridge 500 starts a process in accordance with steps S201 through S203 in FIG. 27 at an appropriate timing. First, in step S201, a used toner quantity after a previous execution of this process is detected. For example, this detection can be physically conducted by using a P sensor 138 and a T sensor 139 shown in FIG. 19. Alternatively, instead of detecting the used toner quantity, the toner residual quantity may be directly detected.

Next, in step S202, a parameter for the toner residual quantity recorded in the NVRAM 504 of the process cartridge 500 is changed in accordance with a detection result in step S201.

After that, in step S203, information concerning the toner residual quantity as a notice of the toner residual quantity is informed to the controller 200. The information may be encrypted by using the shared key replaced in the authentication process as shown in FIG. 8. By encrypting the information, the information concerning the toner residual quantity cannot be leaked even if a signal line is monitored. Therefore, it is possible to prevent contents being transmitted from being leaked and to prevent data as shown in FIG. 26 from illegally being modified.

The shared key used for an encryption is created for the authentication process when the image forming apparatus 100 is activated, and the same shared key may be continued to use until the authentication process is conducted again. Alternatively, the shared key may be newly created by conducting the process shown in FIG. 8 each time a communication with the controller 200 is conducted.

The process at the process cartridge side is terminated after the toner residual quantity is informed.

On the other hand, when the controller 200 receives the notice of the toner residual quantity, the controller 200 starts the process in accordance with steps S211 and S212. This process can be realized by the NRS application 315 shown in FIG. 21. If the notice of the toner residual quantity is encrypted in step S203, this process becomes a process in that the CPU 201 controls the operation of the image forming apparatus 100 in accordance with control information received from the process cartridge 500 through an encrypted communication path.

Subsequently, in step S211, it is determined whether or not the toner residual quantity is less than or equal to a threshold. When it is determined that the toner residual quantity is less than or equal to a threshold, a toner supply call is informed to the managing apparatus 102, and a toner cartridge for a replacement is ordered in step S212. Then, the process at the controller side is terminated. A time lag from an order of the toner cartridge for the replacement until the toner cartridge for the replacement is delivered to a user may be considered, so that this threshold is to be somewhat greater than a threshold showing a toner end or a near end.

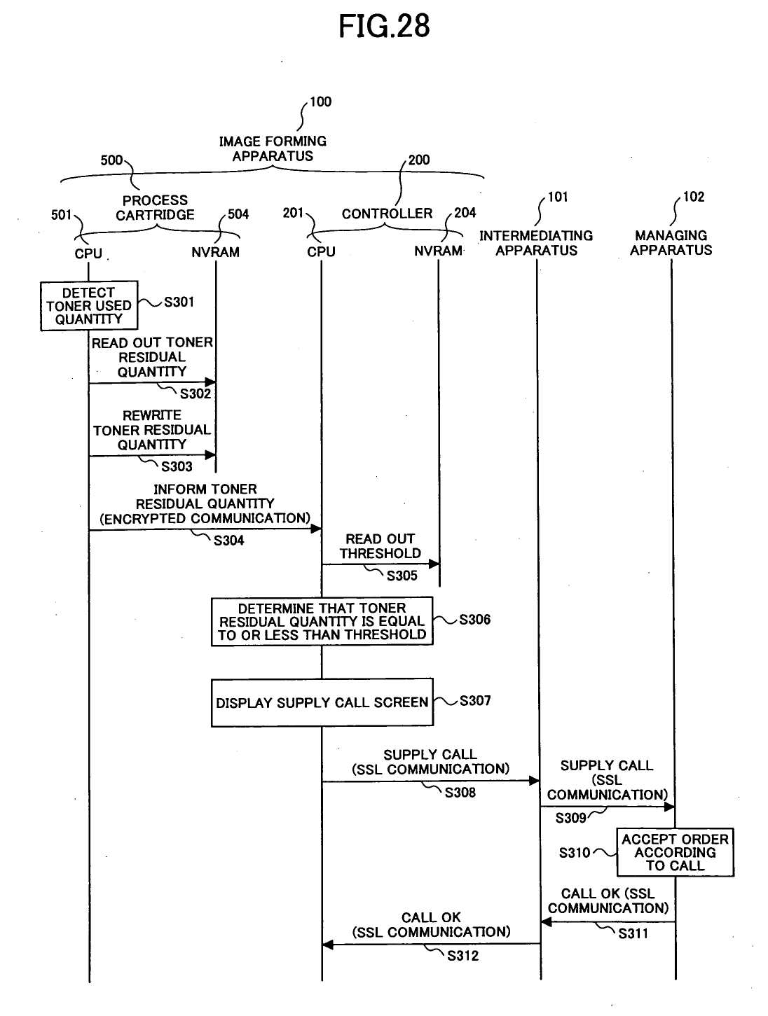

FIG. 28 is a diagram showing an example of an operation sequence when the processes shown in FIG. 27 are conducted, according to the third embodiment of the present invention. In FIG. 28, a case in that the toner residual quantity is less than or equal to the threshold is shown.

As shown in FIG. 28, in this operation sequence, the CPU 501 of the process cartridge 500 detects the used toner quantity at an appropriate timing (step S301), read out the toner residual quantity by accessing the NVRAM 504 (step S302), and rewrites a new toner residual quantity by subtracting the used toner quantity from the toner residual quantity detected in step S301 (step S303). Then, the CPU 501 encrypts information concerning the new toner residual quantity by the shared key, and informs the information being encrypted as a notice of the toner residual quantity to the CPU 201 of the controller 200 (step S304).

On the other hand, when the CPU 201 receives this notice of the toner residual quantity, the CPU 201 read out the threshold of the toner residual quantity from the NVRAM 204, and compares a value of the toner residual quantity shown by the notice with the threshold (step S305). When it is determined that the toner residual quantity is less than or equal to the threshold (step S306), the CPU 201 starts a sending process for sending the supply call in order to order the process cartridge (process cartridge 500) for the replacement.

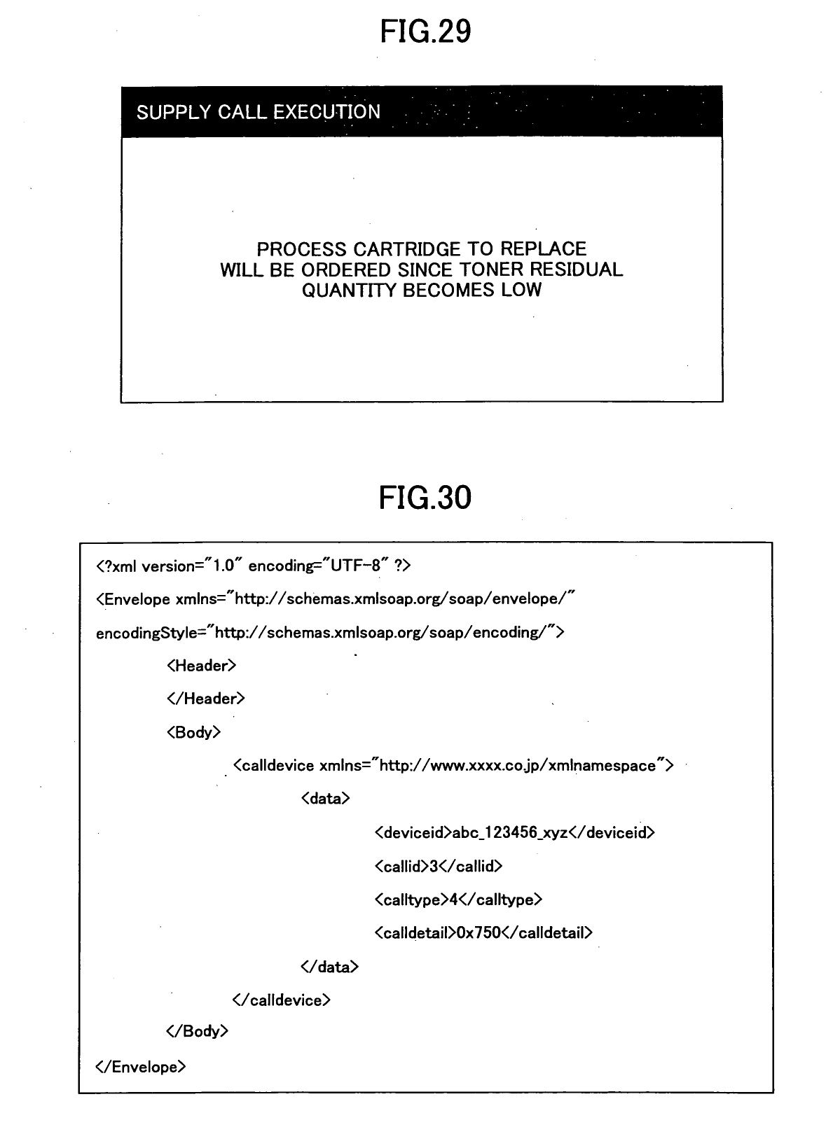

In this operation sequence, a supply call screen as shown in FIG. 29 is displayed at the operating part 209 (step S307). FIG. 29 is a diagram showing a supply call screen displayed in step S307 in FIG. 28, according to the present invention. The supply call screen in FIG. 29 shows a message such as “PROCESS CARTRIDGE TO REPLACE WILL BE ORDERED SINCE TONER RESIDUAL QUANTITY BECOMES LOW”. Then, the supply call is sent to the managing apparatus 102. However, since the image forming apparatus 100 communicates with the managing apparatus 102 through the intermediating apparatus 101, first, the image forming apparatus 100 sends the supply call to the intermediating apparatus 101 (step S308). In this case, the image forming apparatus 100 conducts the authentication process by SSL mutually with the intermediating apparatus 101 (hereinafter, called mutual authentication process) by using the device public key certificate recorded in the NVRAM 204, the device private key, and the root key certificate as described above, so as to establish a secured communication path. This mutual authentication process is conducted similarly to the process shown in FIG. 8 but is conducted between different apparatuses.

Next, when the intermediating apparatus 101 receives the supply call, similarly, the intermediating apparatus 101 establishes the secured communication path with the managing apparatus 102 by SSL, and then transfers the supply call (step S309). When the managing apparatus 102 receives the supply call, the managing apparatus 102 accepts the order of the process cartridge for the replacement indicated by the supply call, and records the information concerning the order to the file server 616 (step S310).

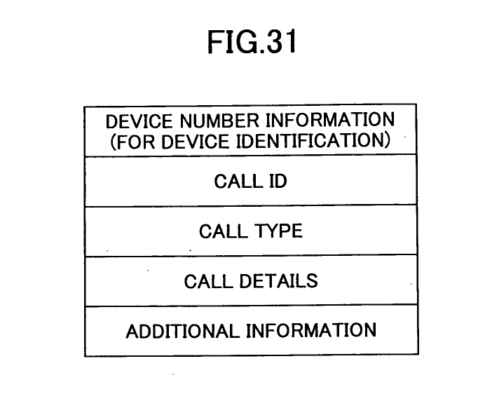

In this case, the supply call sent from the image forming apparatus 100 is described as an SOAP request, and for example, the supply call is described in a format as shown in FIG. 30. FIG. 30 is a diagram showing a description example of the SOAP request concerning the supply call send in step S308 in FIG. 28, according to the third embodiment of the present invention. The SOAP request includes a message as shown in FIG. 31. FIG. 31 is a diagram showing a structure of data included in a body part of the SOAP request shown in FIG. 30. It can be seen from a call type and a call details that this supply call is a call showing the order of the process cartridge for the replacement, and it can be seen from a device number information which device ordered the process cartridge for the replacement. Accordingly, since an address and a telephone number of a place where the apparatus is arranged can be obtained by comparing contents of the message with the customer information recorded in the file server 616, order data can be transferred to a service center located near the place where the apparatus is arranged, so that the process cartridge for the replacement can be promptly delivered to a customer (user).

On the other hand, when the managing apparatus 102 receives the supply call, the managing apparatus 102 replies by sending a call OK notice to the image forming apparatus 100 through the intermediating apparatus 101 as a response with respect to the supply call (steps S311 and S312). This call OK notice is described as a SOAP response.

Then, when the controller 200 receives this call OK notice, the CPU 201 recognizes that the order concerning the process cartridge for the replacement normally ends. In this case, by setting a call end flag to be ON, the same toner supply call can be suppressed until the process cartridge for the replacement, which is delivered, is mounted to the image forming apparatus 100.

After that, the user can generally receive the process cartridge for the replacement before the toner is completely used or nearly completely used. Accordingly, it is possible to replace the old process cartridge being currently used with a new process cartridge promptly when the toner of the old process cartridge is completely used or nearly completely used. Then, when the CPU 201 detects this replacement, the call end flag is set to be OFF, and a regular operation is resumed.

By conducting the process as described above, the user of the image forming apparatus 100 is not required to monitor the toner residual quantity, and to order by phone or a like, but the user can receive the process cartridge for the replacement. Therefore, it is possible for the user to reduce a workload concerning maintenance of the image forming apparatus 100.

Moreover, since a manufacturer allows the user to automatically order the authentic process cartridge of the manufacturer as the process cartridge for the replacement, the manufacture can easily verify the customer as the user. The process cartridge 500 is required to be relatively frequently replace with a new process cartridge in the image forming apparatus 100, and is a relatively expensive consumable component in the image forming apparatus 100. Since the non-authentic process cartridges using recycled authentic process cartridges are in a market, especially in a case in that the present invention is applied to the consumable component such as the process cartridge 500, a greater effect can be expected.

In the third embodiment described above, in other process other than the authentication process, information, which is sent and received between the process cartridge 500 and the controller 200, only process cartridge 500 informs the toner residual quantity to the controller 200.

However, for example, information showing the number of copies is detected by the controller 200, sent to the process cartridge 500, and written in the NVRAM 504. Moreover, it is possible to obtain the used toner quantity by a calculation based on contents of image data concerning the image formation at the control side. In this case, the used toner quantity is detected at the controller side and is sent to the process cartridge 500 to write the used toner quantity in the NVRAM 504.

In addition, for example, in the processes shown in FIG. 27, in a case in that the number of copies is less than or equal to a predetermined number, even if the toner residual quantity is less than or equal to the threshold, the supply call can be suppressed. In this case, the controller 200 requests the process cartridge 500 to send the number of copies, so as to obtain the number of copies recorded in the NVRAM 504 of the process cartridge 500.

Moreover, by using information concerning the expiration date recorded in the NVRAM 504, the supply call can be conducted when the toner cartridge 500 is expired or at a predetermined term prior to the expiration date comes.

As described above, in response to contents of the control in the controller 200, various control information being recorded or to record in the NVRAM 504 is sent or received between the controller 200 and the process cartridge 500. By encrypting this communication similarly to a case of the toner residual quantity as described above, it is possible to reduce chances of leaking and falsifying the control information. Especially, since information such as the number of recycles is closely related to a quality of the process cartridge 500, it is greatly effective to prevent the information from being leaked and falsified.

Moreover, the control information concerning a characteristic of the process cartridge 500 may be recorded at the process cartridge side, and the controller 200 may read out necessary information from the process cartridge 500 to control. In this case, even if the process cartridge 500 being used is moved to another image forming apparatus 100, it is possible to consider an operation history and easily conduct a control operation at another image forming apparatus 100.

Similar to the second embodiment, even if a CPU is not mounted to the process cartridge 500, the process cartridge 500 can be defined as a management subject apparatus of the image forming apparatus 100 functioning as the apparatus managing system.

Moreover, in this configuration, in a case in that the processes as shown in FIG. 27 and FIG. 28 are conducted, all accesses to the NVRAM 504 of the process cartridge 500 are conducted by the CPU 201 from the controller 200. Thus, a communication between the controller 200 and the process cartridge 500 is not encrypted. However, in other cases, the same processes described above in the third embodiment can be conducted, and the same effect can be obtained.

Furthermore, in addition to recording the control information to a predetermined record area in the NVRAM 504, an imaging condition, which is fixed when the process cartridge 500 is manufactured, such as a light exposure, an electrification, and a developing bias may be described in the component public key certificate. The controller 200 may obtain and use the imaging condition for a control of the image formation.

By describing information such as the imaging condition in the component public key certificate, the imaging condition cannot be changed even if a digital certificate and a key are entirely dumped out and copied to another unit and the authentication is successfully conducted. Accordingly, a high quality of the image formation cannot be obtained in a case of using another unit copying the image condition. Therefore, it is effective to describe control information such as the imaging condition to the component public key certificate.

### Variations in Embodiments

In the following, variations in the above-described embodiments will be described.

In the third embodiment described above, the electronic apparatus is the image forming apparatus 100 and the consumable component is the process cartridge 500. The present invention is not limited to this case. For example, in the image forming apparatus 100, a photosensitive drum, an electrostatic unit, a development unit, a toner bottle, a cleaning unit, an optical unit, a transfer unit, a paper cassette unit, a fixing unit, and a like can be individually replaceable and each of them can be handled as a single consumable component. Detailed shape and arrangement of each device or each unit are not limited to the above explanations.

Moreover, each of a plurality of various consumable components may record the public key certificate capable of checking a validity by using the root key certificate recorded in the image forming apparatus using the plurality of various consumable components. The processes described in each embodiment may be conducted for each type of the consumable component or each arrangement. By conducting the processes described in each embodiment, it is possible to obtain the same effects as each embodiment. In this case, for example, if simply it is checked whether or not the consumable component is the authentic component, it is not mandatory to record a different public key certificate for each type of the consumable component. For example, all consumable components may record the certificate as shown in FIG. 12 in common.

Moreover, in the first, the second, and the third embodiments, the electronic apparatus according to the present invention is not limited to the image forming apparatus described above. Alternatively, as well as the image forming apparatus such as a printer, a facsimile, a digital copier, a scanner, a digital multi-functional apparatus, and a like, the present invention can be applied to various electronic apparatuses including a network home electronic apparatus, a vending machine, medical equipment, a power unit, an air conditioning system, a measuring system for gas, water, electricity, and a like, an automobile, an aircraft, and a like.

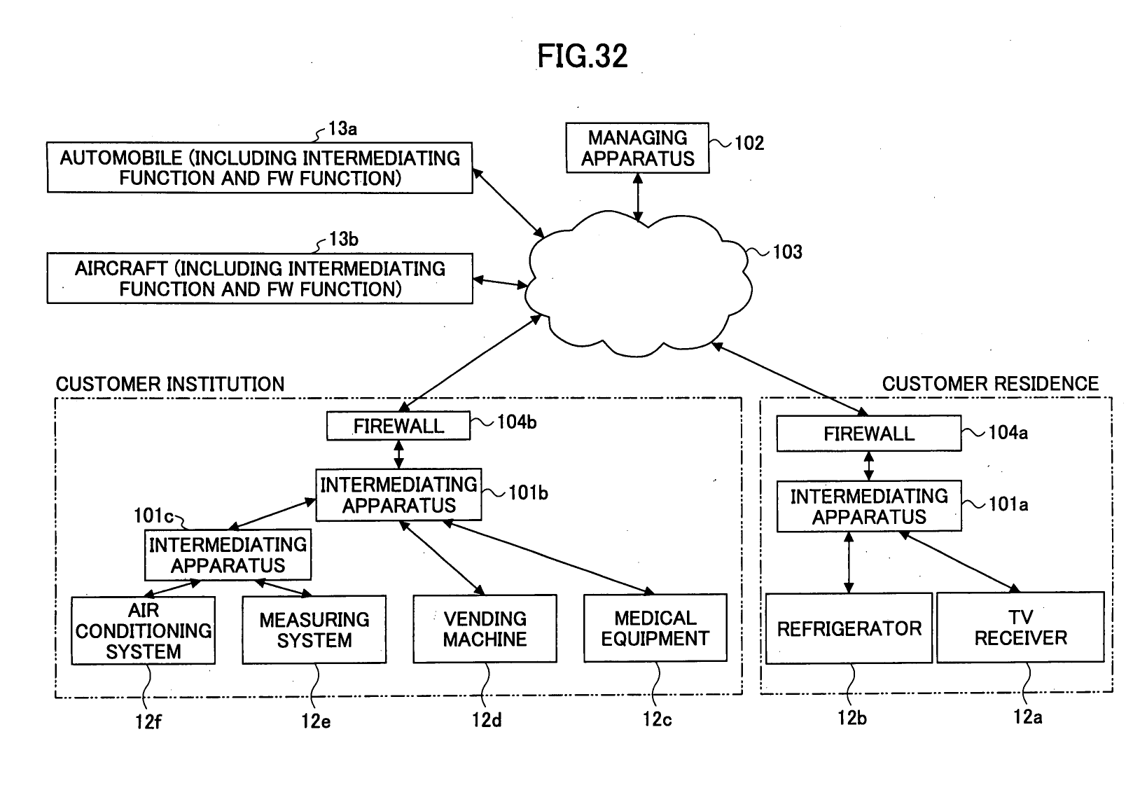

For example, each of the apparatuses 100a through 100f and 110a and 110b are set to be the management subject apparatus in the remote management system shown in FIG. 15, so as to configure the remote management system as shown in FIG. 32. FIG. 32 is a block diagram showing another configuration of the remote management system shown in FIG. 15, according to the third embodiment of the present invention. In FIG. 32, as an example of the management subject apparatuses in a case of separately providing the intermediating apparatuses 101, a TV receiver 12a and a refrigerator 12b as the network home electronic apparatus, medical equipment 12c, a vending machine 12d, a measuring system 12e, and an air conditioning system 12f are illustrated. In addition, as the management subject apparatuses including an intermediating function, an automobile 13a and an aircraft 13b are illustrated in FIG. 32. In this case in that an apparatus moves in a wide range such as the automobile 13a, or the aircraft 13b, a function realizing the firewall (FW) 104c in FIG. 15 is preferably included.

Also, in the remote management system, the present invention can be applied to each apparatus as the management subject apparatus, each component used in the apparatus, and a like.

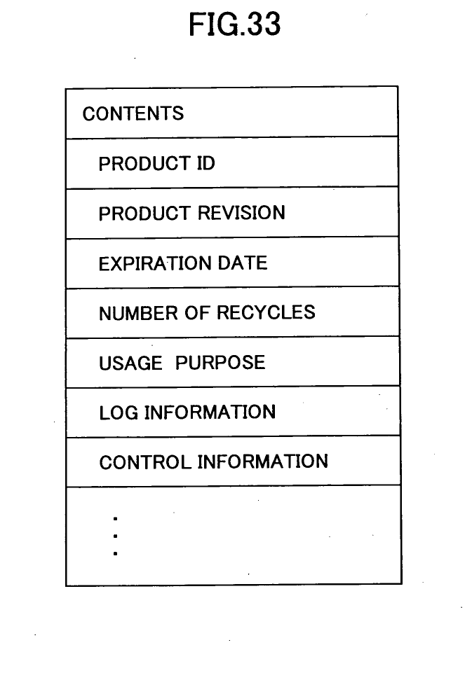

In addition, in each component used in the apparatus, as shown in FIG. 26, as information necessary to rewrite in information concerning the component, information as shown in FIG. 33 is recorded in a predetermined record area in a non-volatile memory, the entire or a part of the information may be used as the control information when an operation of the apparatus is controlled.

In a case such as the third embodiment in that the remote management system is not considered, the communicating part for communicating to an external apparatus is not mandatory. On the other hand, if a communication device is provided as the communicating part for communicating the external apparatus as the managing apparatus and the intermediating apparatus to the electronic apparatus, the communication device can be the management subject apparatus in the remote management system as described in the third embodiment.

In this case, the management subject apparatus is not required to be an apparatus being a special type or having a special function. Communications among nodes forming the remote management system can be conducted by using various communication paths capable of structuring a network.

Furthermore, a communication between the consumable component and the controlling part of the main device in the electronic apparatus is not limited to a fixed line but can be a radio transmission, and a wireless LAN. If the digital certificate is recorded in a device, which is a small size and non-contact and can send and receive information, the device recording the digital certificate can be widely used for various consumable components. Accordingly, the present invention can be widely applied to the consumable components including the device recording the digital certificate and the electronic apparatus using those consumable components.

Also, the present invention is applied to a component that is not always needed to replace periodically, and is used to manage a source of the component and a use history.

Furthermore, even in a case in that a component such as software for causing a computer to operate, music and a video subject to appreciate, or a recording medium recording useful data for other purposes with respect to an information reproduction apparatus such as a computer, a home video game machine, a CD (Compact Disk) player and a DVD (Digital Versatile Disc) player, is not a part of the electronic apparatus, if the component is used in the electronic apparatus, the present invention can be applied. Similarly, in this case, the present invention can be applied to the electronic apparatus using the component.

In addition, various combinations of technologies described above in the embodiments can be used.

Moreover, a program according to the present invention is a program for causing a computer to control the electronic apparatus and conduct the processes described above in the embodiments. The program is executed by the computer and the above-described effects can be obtained.

This program may be stored beforehand in a storing part such as a ROM, an HDD, and a like mounted to the computer. Alternatively, the program may be recorded in the non-volatile recording medium (memory) such as a CD-ROM, a flexible disk, an SRAM, an EEROM, a memory card, and a like, to provide the program to the computer. By causing the computer to read out the program from the memory and execute the program, each of steps described above in the embodiments can be conducted.

Furthermore, by connecting to a network and downloading the program from an external device mounting the recording medium recording the program or an external device recording the program in a recording part, each of steps described above in the embodiments can be conducted.

As described above, regarding the electronic apparatus, the image forming apparatus, a method for controlling the electronic apparatus, an image forming apparatus managing system, the component, the program, or the recording medium recording the digital certificate according to the present invention, even in an environment distributing non-authentic components in market, it is possible to prevent the liability with respect to the apparatus degrade from degrading because of problems of the non-authentic components.

Accordingly, by applying the present invention, it is possible to provide the electronic apparatus that a supplier can easily manage the quality of the electronic apparatus.

The present invention is not limited to the specifically disclosed embodiments, and variations and modifications may be made without departing from the scope of the present invention.

The present application is based on the Japanese Priority Applications No. 2003-418673 filed on Dec. 16, 2003 and No. 2004-339850 filed on Nov. 25, 2004, the entire contents of which are hereby incorporated by reference.

1. An electronic apparatus capable of using a component recording a digital certificate, comprising:
an obtaining part obtaining the digital certificate recorded in the component;
an authenticating part authenticating the component by using the digital certificate; and
a controlling part controlling an operation of the electronic apparatus based on an authentication result by the authenticating part.

2. The electronic apparatus as claimed in claim 1, wherein the component is a replaceable consumable component.

3. The electronic apparatus as claimed in claim 1, further comprising a part informing the authentication result by the authenticating part.

4. The electronic apparatus as claimed in claim 1, wherein the digital certificate is information concerning the component and shows information unnecessary to rewrite.

5. The electronic apparatus as claimed in claim 4, wherein the information unnecessary to rewrite is type information showing a type of the component.

6. The electronic apparatus as claimed in claim 1, further comprising a communicating part communicating with the component being used in the electronic apparatus,
wherein the communicating part sends and receives information necessary to rewrite in information which the component records or is recorded by the component, through an encrypted communication path in which contents are encrypted by using the digital certificate and sends and receives the contents being encrypted.

7. The electronic apparatus as claimed in claim 6, further comprising a controlling part controlling an operation of the electronic apparatus in accordance with control information received from the component through the encrypted communication path.

8. The electronic apparatus as claimed in claim 7, wherein:
the component is a toner supplying member; and
the electronic apparatus is an image forming apparatus comprising:
an image forming part forming an image onto a sheet by using a toner supplied from the toner supplying member; and
a second communicating part communicating with a managing apparatus being externally arranged,
wherein the controlling part includes a part obtaining information showing a toner residual quantity as from the toner supplying member as the control information, and ordering another toner supplying member for a replacement to the managing apparatus by the second communicating part.

9. The electronic apparatus as claimed in claim 1, wherein the digital certificate which the member records is a certificate which validity can be confirmed by using a certificate key special for authenticating the component.

10. The electronic apparatus as claimed in claim 1, wherein:
the component includes an operating part, and a communicating part communicating with a main device of the electronic apparatus; and
the main device of the electronic apparatus includes a recording part recording the digital certificate, wherein a mutual authentication is conducted by using the digital certificate of the component being recorded in the electronic apparatus and the digital certificate of the electronic apparatus being recorded in the component, by the operating part and the authenticating part.

11. A method for controlling an electronic apparatus using a component recording a digital certificate, said method comprising the steps of:
(a) obtaining the digital certificate being recorded in the component; and
(b) authenticating the component by using the digital certificate,
wherein an operation of the electronic apparatus is controlled based on an authentication result in the step (a).

12. The method as claimed in claim 11, wherein the component is a replaceable consumable component.

13. The method as claimed in claim 11, wherein the authentication result in the step (b) is informed to the electronic apparatus.

14. The method as claimed in claim 11, wherein the digital certificate includes information unnecessary to rewrite in that the information is information concerning the component.

15. The method as claimed in claim 11, further comprising the step of (c) communicating with the component in the electronic apparatus in that the electronic apparatus is caused to execute the step (c),
wherein in the step (c), information necessary to rewrite in information, which the component records or is recorded by the component, is sent and received through an encrypted communication path in which contents are encrypted by using the digital certificate and sends and receive the contents being encrypted.

16. The method as claimed in claim 15, wherein the electronic apparatus controls an operation of the electronic apparatus itself in accordance with control information received from the component through the encrypted communication path.

17. The method as claimed in claim 11, wherein:
the digital certificate is recorded in the electronic apparatus, and
in the step (b), a mutual authentication is conducted by using the digital certificate of the component being recorded in the electronic apparatus and the digital certificate of the electronic apparatus being recorded in the component.

18. A computer-readable recording medium recorded with a program for causing a computer to control an electronic apparatus using a component recording a digital certificate, said program comprising the codes for:
(a) obtaining the digital certificate being recorded in the component; and
(b) authenticating the component by using the digital certificate,
wherein an operation of the electronic apparatus is controlled based on an authentication result by the code (a).

19. The computer-readable recording medium as claimed in claim 18, wherein the component is a replaceable consumable component.

20. The computer-readable recording medium as claimed in claim 18, wherein the authentication result by the code (b) is informed to the electronic apparatus.

21. The computer-readable recording medium as claimed in claim 18, wherein the digital certificate includes information unnecessary to rewrite in that the information is information concerning the component.

22. The computer-readable recording medium as claimed in claim 18, further comprising the code for (c) communicating with the component in the electronic apparatus in that the electronic apparatus is caused to execute the code (c),
wherein by the code (c), information necessary to rewrite in information, which the component records or is recorded by the component, is sent and received through an encrypted communication path in which contents are encrypted by using the digital certificate and sends and receive the contents being encrypted.

23. The computer-readable recording medium as claimed in claim 19, wherein an operation of the electronic apparatus is controlled in accordance with control information received from the component through the encrypted communication path.

24. The computer-readable recording medium as claimed in claim 19, further comprising the codes for recoding the digital certificate,
wherein by the code (b), a mutual authentication is conducted by using the digital certificate of the component being recorded in the electronic apparatus and the digital certificate of the electronic apparatus being recorded in the component.

25. A program for causing a computer to control an electronic apparatus using a component recording a digital certificate, said program comprising the codes for:
(a) obtaining the digital certificate being recorded in the component; and
(b) authenticating the component by using the digital certificate,
wherein an operation of the electronic apparatus is controlled based on an authentication result by the code (a).

26. An image forming apparatus managing system, comprising:
an image forming apparatus, comprising:
an obtaining part obtaining a digital certificate recorded in a component;
an authenticating part authenticating the component by using the digital certificate;
a controlling part controlling an operation of the image forming apparatus based on an authentication result by the authenticating part;
a communicating part communicating with the component being used in the image forming apparatus, wherein the communicating part sends and receives information necessary to rewrite in information which the component records or is recorded by the component, through an encrypted communication path in which contents are encrypted by using the digital certificate and sends and receives the contents being encrypted;
a controlling part controlling an operation of the image forming apparatus in accordance with control information received from the component through the encrypted communication path;
a toner supplying member as the component;
an image forming part forming an image onto a sheet by using a toner supplied from the toner supplying member; and
a second communicating part communicating with a managing apparatus being externally arranged, wherein the controlling part includes a part obtaining information showing a toner residual quantity as from the toner supplying member as the control information, and ordering another toner supplying member for a replacement to the managing apparatus by the second communicating part, and
a managing apparatus for managing the image forming apparatus,
wherein the managing apparatus includes a receiving part receiving an order of the toner supplying member for a replaceable from the image forming apparatus.

27. A component capable of recording a digital certificate, comprising a record area recording the digital certificate, which validity can be confirmed by using a certificate key being recorded in an electronic apparatus using the component.

28. The component as claimed in claim 27, wherein the component is used as a replaceable consumable component in the electronic apparatus.

29. The component as claimed in claim 27, wherein the digital certificate is information concerning the component and includes information unnecessary to rewrite.

30. The component as claimed in claim 29, wherein the information unnecessary to rewrite is type information showing a type of the component.

31. The component as claimed in claim 27, further comprising a communicating part communicating with the electronic apparatus using the component,
wherein the communicating part sends and receives the information unnecessary to rewrite in the information being recorded in the component, through an encrypted communication path in which contents are encrypted by using the digital certificated being recorded in the component.

32. The component as claimed in claim 27, wherein the digital certificate being recorded in the component is a digital certificate which validity can be confirmed by using a certificate key special for authenticating the component.

33. The component as claimed in claim 27, further comprising:
a communicating part communicating with the electronic apparatus using the component; and
an authenticating part obtaining a digital certificate from the electronic apparatus and authenticating the electronic apparatus by using the digital certificate.
